(19) United States
(12) Patent Application Publication
(10) Pub. No.: US 2011/0188043 A1
(43) Pub. Date: Aug. 4, 2011

(54) METHOD AND APPARATUS FOR MONITORING PROCESSES IN LIVING CELLS

(75) Inventors: Dan Davidov, Jerusalem (IL); Benjamin Aroeti, Jerusalem (IL); Michael Golosovsky, Maale Adumin (IL); Vladislav Lirtsman, Jerusalem (IL)

(73) Assignee: Yissum, Research Development Company of The Hebrew University of Jerusalem, Ltd., Jerusalem (IL)

(21) Appl. No.: 12/735,262

(22) PCT Filed: Dec. 25, 2008
(86) PCT No.: PCT/IL2008/001671

§ 371 Date: Oct. 12, 2010

Related U.S. Application Data
(60) Provisional application No. 61/006,138, filed on Dec. 26, 2007.
(60) Provisional application No. 61/042,116, filed on Apr. 3, 2008.

(51) Int. Cl. G01N 21/55

(52) U.S. Cl. 356/445

(57) ABSTRACT

The invention provides a method and apparatus for monitoring processes in living cells by measuring optical reflectivity by Surface Plasmon Resonance at the surface and/or inside living cells attached to a thin metal film (28), wherein said thin metal film is attached or optically coupled to a base of a prism (27) such that a collimated and optically polarized light beam (6c) in the near-infrared and/or mid-infrared wavelength ranges directed to a side surface of the prism is internally reflected by said prism at its base (27b) and measured by detector means (33) capable of measuring the intensity and optionally also polarization or phase of the reflected beam (6r).

### FIELD OF THE INVENTION

The present invention relates to a Surface Plasmon Resonance (SPR) technique for real time monitoring of dynamic processes at the surface of, and inside living cells. More particularly, the present invention relates to a SPR method and system operating in the mid-infrared wave length range and capable of detecting dynamic processes occurring in living cells, and to methods and configurations for culturing the living cells.

### BACKGROUND OF THE INVENTION

Cells, even the simplest ones, display a remarkable degree of complexity, reflected by their unique and specific abilities to interact with each other, and with various molecules of life (e.g., proteins, lipids, carbohydrates, etc). The complexity of cells poses an enormous difficulty in evaluating the precise mode by which molecules of life and other materials such as drugs, toxins and pathogens interact with them. A major challenge in modern pharmacology is to develop new experimental strategies for monitoring the dynamic interactions between molecules of biomedical significance and cognate targets in living cells. An important requirement for these techniques would be to provide sensitive and on-line monitoring of interactions while preserving the intactness of cells and tissues. To date, biomolecules are typically identified by labeling with fluorescent, radioactive, or other chemical tags. However, there is always a risk that labeling can alter the physiological activity of the interacting ligands. This leads to a requirement for label-free detection means.

Surface Plasmon Resonance (SPR) is the resonant excitation of the surface electromagnetic wave propagating at the metal-dielectric interface, which is becoming an important research tool in biophysics due to its potential for biosensing and potential commercial implementations. The SPR technique measures the refractive index or optical absorption with high sensitivity and is particularly advantageous for biosensing since it is a label-free method, and due to its capability of real time monitoring the kinetics of biological processes.

SPR in the visible range has been used to study membranes [Alves et al., Current Protein and Peptide Science 6, 293 (2005); Besenicar et al., Chemistry and Physics of Lipids 141, 169 (2006), Dahlin et al., Biophys. J. 91, 1925 (2006); Pattnaik, Applied Biochemistry and Biotechnology 126, 79 (2005); Salamon et al., Biochimica et Biophysica Acta 1331, 117 (1997); Salamon et al., Biophys. J. 84, 1796 (2003)] and cell cultures [Fang et al., Biophys. J. 91, 1925 (2006), Giebel et al., Biophys. J. 76, 509 (1999), Hide et al., Anal. Biochem. 302, 28 (2002), Yanase et al., Biosensors and Bioelectronics 22, 1081 (2007)].

The SPR technique has been used in several modalities such as SPR-enhanced fluorescence [Liebermann and Knoll, Colloids and Surfaces A 171, 115 (2000)], SPR imaging [W. Knoll, Annu. Rev. Phys. Chem. 49, 569 (1998), Brockman et al., Ann. Rev. Phys. Chem. 51, 41 (2000)], and SPR spectroscopy [A. A. Kolomenskii, P. D. Gershon, and H. A. Schuessler, Appl. Optics 39, 3314 (2000); Zangeneh et al., Appl. Spectroscopy 58, 10 (2004); Coe et al., J. Phys. Chem. 111, 17459 (2007); and Zhi].

Conventional SPR applications (e.g., such as available through Biacore and Bio-Rad) typically operate in the visible and near-visible wavelength range, from 600 to 800 nm, at a fixed wavelength and at variable angle of incidence. These conventional applications typically utilize glass-based optics, which limits their operation to the visible and NIR wavelength range (near-infrared 0.75-1.4 μm wavelength range). Surface-plasmon waves in the visible range, characterized by shallow penetration of less than 250 nm, are useful for studying monomolecular layers that are in contact with the sensor's surface. This is why SPR is popular for quantitative studies of dynamic interactions in thin biolayers, including molecular recognition or binding events. However, visible-range SPR is not suitable for studying processes occurring inside living cells since the cells' size considerably exceeds the penetration depth of visible-range surface-plasmon waves.

It was already shown that FTIR-SPR (Fourier-Transform-Infra-Red SPR) in the near-infrared can sense in real time: 1) subtle changes in cholesterol levels on membranes of living cells [Ziblat, R., et al., “Infra-Red Surface Plasmon Resonance—a novel tool for real-time sensing of variations in living cells”, Biophys J:90, 2592-2599, 2006]; 2) the degree of surface occupancy by cells, and by synthetic lipids [Ziblat, R., et al. Biophys J:90, 2592-2599, 2006, and Lirtsman, V. et al., “Surface-Plasmon-Resonance with infrared excitation: studies of phospholipid membrane growth”, J. Appl. Phys. 98:Art. No 093506, 2005].

Recently, several SPR techniques operating in the near-infrared range have appeared [G. Brink, H. Sigl, E. Sackmann, Sensors and Actuators B 24-25, 756 (1995); A. Ikehata, et al., Appl. Phys. Lett. 83 (2003); A. Ikehata, et al., Anal. Chem. 76, 6461 (2004); J. F. Masson, et al., Appl. Spectroscopy 60, 1241 (2006), S. Patskovsky, et al., J. Opt. Soc. Am. A 20, 1644 (2003); S. Patskovsky, et al., Sensors and Actuators B 97, 409 (2004)], some of which use an FTIR spectrometer as a light source [A. G. Frutos, et al., Anal. Chem. 71, 3935-3940 (1999); B. P. Nelson, et al., Anal. Chem. 71, 3928 (1999); V. Lirtsman, et al., J. Appl. Phys. 98, 93506 (2005); R. Ziblat, et al., Biophys. J. 91, 776-776 (2006)].

U.S. Pat. No. 6,330,062 describes an apparatus for measuring adsorption of molecules onto a thin metallic surface by measuring the reflectance spectra obtained in response to surface plasmon resonance excitation at a prism/metallic-film/sample surface at a fixed angle of incidence employing FT spectroscopy.

It is an object of the present invention to provide an SPR apparatus, and methods employing the same, operating in the mid-infrared wave lengths range.

It is another object of the present invention to provide a fast multi-wavelength measurement SPR technique capable of detecting in real time SPR at varying wavelengths and/or varying angles of incident.

It is a further object of the present invention to provide a SPR apparatus and methods that can be tuned to detect specific spectral ranges (absorption bands) for allowing detection of biomolecules in solution or in living cells (so-called “fingerprints”).

It is yet another object of the present invention to provide a SPR apparatus and methods for real time monitoring of dynamic processes at the surface of, and inside living cells.

It is yet a further object of the present invention to provide a SPR apparatus and methods having greater penetration depths of the surface plasmon suitable for studying cells and cell cultures.

It is an additional object of the present invention to provide cells cultures, and methods for growing the same, with improved adherence and growth on Au-coated prisms/slides.

It also an object of the present invention to provide a SPR technique capable of operating in the Otto geometry;

Yet another object of the present invention is to provide an SPR technique for real time monitoring of dynamic processes at the surface of, and inside living cells, wherein cells are cultured on a replaceable slide.

### SUMMARY OF THE INVENTION

The present invention provides a label-free system and method for on-line detecting and monitoring changes at the surface and inside living cells by surface plasmon resonance (SPR) means employing a light source in the near-IR and mid-IR wavelength ranges (0.75-12 μm), particularly in the mid-IR range (5-12 μm).

The inventors of the present invention discovered that SPR measurements in mid-IR wavelength range can be used as a sensitive label-free monitoring means for detecting in real-time changes occurring inside, and on the surface of, living cells. For this purpose a FTIR-based SPR system was developed, that allows measuring changes in IR reflectivity of a prism (e.g., ZnS prism) which base surface is covered by a metallic (e.g., gold, silver, or copper) layer (e.g., having surface area of about 20×40 mm² and thickness in the range of 8-50 nm) onto which living cells (e.g., human melanoma cells) were cultured, wherein said base surface of said prism is enclosed within a flow chamber allowing to maintain the cultured cells in close contact with liquid composition comprising molecules with biological activity.

In order for the system to monitor changes inside living cells the IR radiation source is adapted to provide IR radiation in the mid-IR wavelength range. For this purpose an IR radiation source was designed which comprise beam shaping means implemented by two focusing mirrors or lenses and a collimator disposed therebetween, said beam shaping means is adapted to direct the beam to the prism via polarizing means and via an optional shutter/iris. The sensitivity of the system is maximized by an optimization process wherein preferable incident angles, metallic film thicknesses and IR wavelengths are determined by means of a numerical simulation carried out for each specific biomolecule to be introduced into the flow chamber.

In one aspect the present invention relates to an apparatus for measuring optical reflectivity by Surface Plasmon Resonance inside, and on the surface of, living cells attached to a thin metal film, the system comprising a light source for producing a light beam, a prism having a base and side surfaces, wherein said base surface is covered by a thin metallic layer, beam processing means capable of collimating and polarizing said light beam and directing said beam to the metal coated base of the prism such that said beam is internally reflected by said prism at its base and detector means (e.g., liquid nitrogen cooled MCT detector) capable of measuring the intensity and optionally also polarization or phase of the reflected beam, wherein the light source is an infrared light source (e.g., single wave length, or multi wavelength, for example FTIR source) capable of emitting a light beam in the near-infrared and/or mid-infrared wavelength ranges.

Advantageously, the base surface of the prism is horizontal to ground surface.

The apparatus may further comprise optical means for conveying the light from the light source to said base surface, and for conveying the reflected beam to the detector means.

The apparatus may further comprise a medium holding chamber in contact with said thin metallic film, or a portion thereof, for prolonging the life of the living cells.

The beam processing means may comprise polarizing means and beam shaping means comprising a pinhole (e.g., of about 1-mm diameter) mounted between two focusing devices (e.g., focusing mirrors or lenses, or the like), said beam shaping means is adapted to direct a collimated beam to said prism via said polarizing means. The apparatus may further comprise a shutter or iris placed in the light path of the reflected or incident beam for illumination or measuring different regions of the sample. For example, the apparatus may comprise a movable or rotatable shutter disposed in the path of the incident beam i.e., between the beam processing means and the prism, for taking measurements from at least two different regions on the prism base.

The medium holding chamber is preferably a flow chamber suitable for streaming a liquid composition, said liquid composition preferably comprises molecules with biological activities.

Optionally, the thin metal film is attached to a replaceable surface capable of being reversibly attached to the base surface of the prism and optically couple between said thin metal film and said prism. Preferably, the replaceable metal-coated surface is attached to the prism according the Kretschmann configuration.

In one specific preferred embodiment the portions of the base surface of the prism are coated by metallic (e.g., gold, silver, or copper) patches (e.g., each patch having surface area of about 5×5 to 200×200 μm and thickness in the range of 10-50 nm), wherein living cells are cultured on one or more of said metallic patches such that clusters of said cells can be detected and monitored.

According to one specific preferred embodiment the prism is a rotatable prism adapted to provide a desirable angle of incidence. Alternatively, the prism is a movable (translated) prism and the optical means (e.g., flat mirrors) are made rotatable for conveying the light from the light source to said base surface to achieve a desired angle of incidence.

According to another aspect the present invention is directed to an apparatus for measuring optical reflectivity by surface Plasmon resonance on moieties (e.g., living cells, and molecules, solutions, membranes) attached to a thin metal film, comprising: light source for producing a light beam, prism (e.g., ZnS prism) having a base and side surfaces; and a detachable metal coated (e.g., gold film having thickness in the range of 10-50 nm) surface capable of being optically linked to said base surface; said moiety mounted at a distance from the base of the prism (e.g., such as in the Otto configuration); beam processing means capable of collimating and polarizing said light beam and directing said beam through the prism to the metal coated surface such that said beam is reflected by said surface; detector means capable of measuring the intensity and optionally also polarization or phase of the reflected beam, wherein the infrared light source (e.g., single wave length, or multi wavelength) is capable of emitting a light beam in the mid-infrared wavelength ranges.

The apparatus may further comprise optical means for conveying the light emitted by the light source to the base surface of the prism, and for conveying the beam reflected from the prism to the detector means.

The apparatus may further comprise a medium holding chamber (e.g., flow chamber) in contact with said thin metallic film, or a portion thereof, for prolonging the life of the living cells.

The beam processing means may comprise polarizing means and beam shaping means comprising a pinhole mounted between two focusing devices (mirrors, lenses, etc.), said beam shaping means is adapted to direct a collimated beam to said prism via said polarizing means.

The apparatus may further comprise a shutter or iris placed in the light path of the reflected or incident beam for illumination or measuring different regions of the sample. For example, the apparatus may comprise a movable or rotatable shutter disposed in the path of the incident beam i.e., between the beam processing means and the prism, for taking measurements from at least two different regions on the prism base.

Optionally, the thin metal film is composed from a number of thin metal patches of about 5×5 to 200×200 μm and thickness in the range of about 10 to 50 nm.

Optionally, the prism is a rotatable prism adapted to obtain a desired angle of incidence. Alternatively, the prism is a movable prism and the optical means are rotatable.

In another aspect the present invention is directed to a method for measuring optical reflectivity by surface Plasmon resonance at the surface and/or inside living cells attached to a thin metal film, the method comprising: providing an apparatus for measuring optical reflectivity by Surface Plasmon Resonance as described hereinabove, or hereinbelow; placing the cells/membranes on the metal coated surface; irradiating the cells by a light beam in the near-infrared and/or mid-infrared wavelength ranges; establishing the angle of incidence corresponding to the excitation of the surface Plasmon resonance; and measuring reflectivity (e.g., measuring the intensity, the polarization, and/or phase of the reflected beam).

The reflectivity measurements may be carried out by a single wavelength or by measuring a spectra of wavelengths (i.e. reflectivities at different wavelengths).

Advantageously, measurements are taken from at least two regions in the sample, simultaneously or sequentially.

The angle of incidence may be varied in the range that enables surface Plasmon resonance.

The method may further comprise applying to the cells an external stimuli, such as, but not limited to, irradiation, Temperature, pH, ionic contact, effectors molecules, drugs, hormones, metabolites, or by cells (eukaryotic and prokaryotic) and viruses and phages.

According to yet another aspect the invention is directed to a method for measuring optical reflectivity by surface Plasmon resonance at the surface and/or inside living cells attached to a thin metal film, comprising: providing an apparatus for measuring optical reflectivity by Surface Plasmon Resonance as described hereinabove, or hereinbelow; placing the cells/membranes on the metal coated surface; irradiating the cells by a light beam in the near-infrared and/or mid-infrared wavelength ranges; establishing the angle of incidence corresponding to the excitation of the surface Plasmon resonance and the distance between the base of prism and the metal-coated surface; and measuring reflectivity (e.g., measuring the intensity, the polarization, and/or phase of the reflected beam).

The reflectivity measurements may be carried out by a single wavelength or by measuring a spectra of wavelengths (i.e. reflectivities at different wavelengths). Advantageously, the measurements may be taken from at least two regions in the sample, simultaneously or sequentially.

The angle of incidence may be varied in the range that enables surface Plasmon resonance.

The method may further comprise applying to the cells an external stimuli, such as but not limited to, irradiation, temperature, pH, ionic contact, effectors molecules; drugs, hormones, metabolites, or by cells, such as eukaryotic, prokaryotic, viruses, and/or phages, which may be added to the solution introduced into the flow chamber.

In still another aspect the present invention relates to a method for detecting and monitoring changes inside, and/or on the surface, of living cells, the method comprising:
culturing living cells on a metallic layer covering the base surface of a prism, wherein said living cells and at least a portion of said metallic layer are enclosed within a flow chamber;
determining optimal wavelengths and incident angles for maximizing measurements sensitivity based on substances to be introduced into the flow chamber;
filling said flow chamber with, or streaming therethrough, a liquid composition comprising said substances;
directing collimated IR rays to said prism and measuring the IR reflectivity therefrom before and after said substances are introduced into said flow chamber; and
determining changes occurring inside said living cells, or on their surfaces, upon changes in the measured IR reflectivities.

The step of determining optimal wavelengths and incident angles may be performed by means of a numerical simulation. The simulation may comprise the following steps:
1. Calculation of the real and imaginary parts of the refractive index as a function of the biomolecule concentration;
2. Calculation, using Fresnel reflectivity formulae, of the beam reflectivity as a function of wavelength and incidence angle for a film of certain thickness;
3. Identifying wavelength and incidence angle of maximal sensitivity, determination of the possible concentration sensitivity, the upper concentration range, and thus also the measurement dynamic range.

In one embodiment, the numerical simulation is used in the measurement design phase. In another embodiment, the numerical simulation is used for the measurement analysis phase.

In another specific preferred embodiment of the invention the FTIR-SPR apparatus includes spatial resolution capabilities.

In yet another specific preferred embodiment, tomographic measurements are performed at various wavelengths, each at optimal incidence angle, such that the measurement provides SPR information on slices at different heights above the surface of the metallic film, and thus allows identifying the location of the different biomolecules and organelles within cells.

In a further preferred embodiment of the invention, the high sensitivity of the FTIR-SPR apparatus of the present invention is used for two-dimensional microscopy, by employing micron-scale gold film patches placed on the base of the SPR prism, whereas the patch size is determined upon ability to produce a detectable signal and the thickness of the gold patches matches the condition for the observation of SPR reflection minima, thereby enabling the detection and the monitoring of cells cultured on said patches.

### BRIEF DESCRIPTION OF THE DRAWINGS

In the drawings:

FIGS. 1A and 1B demonstrate that SPR excitation by mid-infrared radiation can sense the entire cell volume, wherein FIG. 1A schematically illustrates the SPR penetration depth into the cell in the visible light range and FIG. 1B demonstrates that in the infrared range the penetration depth of the SPR is larger;

FIG. 2 show graphical plots of the penetration depth 5 and sensitivity S as a function of the SPR wavelength;

FIG. 3A schematically illustrate a FTIR SPR monitoring system according to a preferred embodiment of the invention employing ZnS/Au/solution interface at different angles of incident, an FTIR source as a light source, and a mercury-cadmium-telluride (MCT) detector;

FIGS. 3B and 3C schematically illustrates alternative setups based on the Kretschmann and Otto configurations, respectively, wherein the cells are cultured on a gold layer provided on a replaceable slide;

FIGS. 3D to 3G schematically illustrate embodiments of the invention utilizing a movable/rotatable shutter, wherein FIG. 3D shows a setup employing a movable shutter, FIG. 3E shows a possible rotatable shutter, and FIGS. 3F and 3G demonstrates measurements taken from different portions of the cultured cells;

FIG. 4 schematically illustrates FTIR-SPR measurement setup for measuring changes in cells cultured on micron-scale gold patches;

FIG. 5 shows graphical plots of: (A) FTIR transmission spectrum of a pure methanol with a specific absorption minimum (fingerprint) at 2840 cm-1; (B) the magnitude of the SPR minimum for two methanol concentrations, ΔR=R_{water}−R_{water+methanol}; and (C) the shift in wavelength of the SPR minimum, the computer simulations in the plots in (B) and (C) show a similar dependence to that shown for the transmission spectrum which reveals the existence of fingerprints by SPR measurements;

FIG. 6 shows graphical plots demonstrating fingerprints of: (A) dry glucose as measured by FTIR transmission spectrum spectroscopy; and (B) by FTIR-SPR, the derivative (with respect to the wavelength), of the SPR shift measured at different angles of incidence, wherein the sample is a 0.3% (w/v) solution of D-glucose in water, and the arrows in the figure indicate specific absorption minima for the glucose obtained by these two different techniques, which demonstrates that the SPR data largely agree with the transmission spectroscopy data;

FIG. 7 schematically illustrates cell culture in preparation for SPR measurements;

FIG. 8 shows an optical micrograph of a MEL 1106 cell monolayer cultured on an Au-coated ZnS prism of the invention;

FIGS. 9A and 9B shows the shift in the SPR signal in the presence of cells, wherein FIG. 9A shows graphical plots of FTIR-SPR spectrum obtained with and without cells cultured on an Au-coated prism, and FIG. 9B shows SPR signals obtained for melanoma cell monolayers exposed to holo-Tfn at 37° C. and monitored at three different time points;

FIGS. 10A to 10C show real-time fluorescence imaging of Rhodamine Red Tfn endocytosis, wherein FIG. 10A shows cells exposed to Rhodamine Red holo-Tfn, lissamine Rhodamine apo-Tfn, and treated with CPZ followed by washout with plain MEM/BSA and then treated with Rhodamine Red holo-Tfn, FIG. 10B exemplifies how an area of interest (the solid white line), basically defined by SRG delineating the cell boundaries at a particular optical section, was chosen for the fluorescence quantitative analyses of Tfn internalization, and FIG. 100 shows graphical plots of the average of intracellular fluorescence intensity of Tfn normalized to the extracellular background recorded from at least five different cells in each case;

FIG. 11 shows bar graphs of human Tfnr presence measured in cultures of HeLa, A431, and Melanoma 1106 cells, and a representative immunoblot (upper pannel) showing the presence of a 90-kDa protein band, immunocrossreacting with the H68.4 monoclonal anti-human transferrin antibody;

FIGS. 12A and 12B show graphical plots showing time course of SPR signal shifts recorded in response to Tfn treatment, wherein FIG. 12A shows effects of holo or apo-Tfn introduced into a Au-coated prism cultured (+ cells), or without (− cells), with melanoma cells, and FIG. 12B shows effects of ligand introduction and removal: in panel (a) the cells were treated with holo-Tfn and SPR measurements were conducted for up to 15 mm; in panel (b) the cells were washed with 5 ml of MEM/BSA lacking ligand, and SPR measurements were performed for 15 min under the same conditions, the washout period proceeded for additional 40 min, during which the SPR recordings were ceased; and in panel (c) holo-Tfn was re-administered for 15 min, during which SPR recordings were resumed;

FIGS. 13A and 13B shows reflectivity graphical plots of effects of CPZ treatment on Tfn-induced SPR shifts, wherein FIG. 13A upper panel shows intensities measured on the SPR signal with cell treated with CPZ and the lower panel shows the intensity measure without cells, and wherein FIG. 13B shows Tfn impact on the SPR signal shifts in CPZ-treated cells and in untreated cells;

FIGS. 14A and 14B shows graphical plots of fluorescence intensities for Tfn-induced SPR shifts obtained in different temperatures, wherein FIG. 14A shows results of FTIR-SPR measurements obtained in 37, 30 and 19° C. temperatures, and FIG. 14B shows Rhodamine Red Tfn fluorescence accumulation at 37 or 30° C.;

FIGS. 15A and 15B shows graphical plots of reflectivity and fluorescence intensity showing effects of acute cholesterol depletion and replenishment on Tfn-induced SPR shifts, wherein FIG. 15A shows FTIR-SPR measurements obtained for Cholesterol depletion achieved by exposing cells to mβCD (3 mM) for 15 min at 37° C. (rectangles), FTIR-SPR measurements obtained after the complex was washed with plain MEM/BSA (circles), and after introducing holo-Tfn (triangles), and wherein FIG. 15B shows a graphical plot of fluorescence intensity obtained with cells which were cholesterol depleted, or replenished, or left untreated;

FIG. 16 shows graphical plots of SPR angular width vs. wavelength for the ZnS/Au/water interface as determined by the absorption in water and in the Au film and by the coupling (radiation) losses;

FIG. 17 shows the optimal Au film thickness that was determined from numerical simulations based on Fresnel reflectivity formulae;

FIGS. 18A to 18C show graphical plots of the SPR reflectivity from the ZnS/Au/water interface for a gold film thickness of 13 nm and incident angle of Θₑₓₜ=21° obtained with water and with 1 wt. % of D-glucose solution in water;

FIG. 19A show calculated sensitivity curves according to the denotation illustrated in FIG. 19B, wherein FIG. 19A shows sensitivity curves calculated for different beam divergences, and FIG. 19B schematically illustrates angles of incident, refraction and reflection, in the Au coated prism;

FIG. 20 shows a graphical plot of the SPR penetration depth into biolayer (aqueous solution) vs. wavelength, indicating spectral windows where SPR at the Au-water interface can be excited;

FIG. 21 shows a graphical plot of the propagation length vs. wavelength at the ZnS/Au/water interface, wherein the dash-dotted line denotes surface plasmon wavelength (sp), and the areas denoted as I and II indicate spectral windows where SPR can be excited, and the dashed line denotes lateral cell size;

FIGS. 22A and 22B show graphical plots of glucose uptake by erythrocyte suspension obtained with a long-wavelength surface plasmon at 4 μm and a 12-nm-thick Au film utilized for achieving a sufficiently high penetration depth, δ_{zd}=4.5 μm, which is comparable to the typical erythrocyte diameter, FIG. 22B shows the SPR reflectivity from the erythrocyte suspension before and after exposure to 10 mM of D-glucose showing that the SPR minimum shifts with time to longer wavelengths (red-shift), thus indicating glucose uptake by erythrocytes;

FIG. 23 shows reflectivity curves showing angular dependency of the SPR in the HeLa cell monolayers with different cell coverage (confluence), obtained using an SF-11 right-angle glass prism coated with a 35-nm-thick Au film;

FIG. 24 shows reflectivity curves in the SPR regime obtained for a Melanoma 1106-cell culture in MEM growth solution (upper curve, Θ=19.5°, and growth solution without cells (lower curve, Θ=18.6°;

FIGS. 25A to 25F schematically illustrate surface plasmon propagation in biological samples, wherein FIG. 25A illustrates measurements in a thick biolayer (solution or bulk sample) in which the surface plasmon decays within this layer and is not sensitive to anything beyond it, FIG. 25B illustrated cell suspension, for example, erythrocytes, for which the surface plasmon partially or fully penetrates into cells that are close to the metal film, which therefore can be used to study cells, FIG. 25C illustrates measurements in a thin biolayer in contact with metal (membrane, adsorbed molecules), which may be employed for studying such thin layers wherein the SP penetration depth should be short enough, FIG. 25D illustrates a biolayer of intermediate thickness in contact with metal, for which, in addition to the exponentially decaying SP wave, guided modes having sinusoidal field distribution can be excited as well inside the layer and may be advantageous for layer characterization, FIG. 25E illustrates cell culture grown on metal, wherein the SP propagation length is smaller than the lateral cell size wherein the reflectivity in the SPR regime represents a sum of the contributions of individual cells, and FIG. 25F illustrates measurements in which the SP propagation length exceeds lateral cell size, wherein the SP probes an “effective medium” consisting of cells and extracellular space;

FIG. 26 illustrates surface plasmon resonance shift upon cholesterol enrichment/depletion of HeLa cell membranes, schematically showing cholesterol molecules in the cell membrane (oval shaped images); the numbers below the oval shaped images indicate cholesterol concentration in the membrane, as was determined biochemically on analogous cell cultures; in order to be sensitive to membrane-related processes, the SPR measurements were performed at a short wavelength, λ=1.08 μm, to ensure short penetration depth, δ_{zd}=0.36 μm;

FIGS. 27A and 27B illustrate cell fluorescence resulting from the Rhodamine-tagged ferrotransferrin (Ft) penetration into cells, wherein FIG. 27A graphically plots fluorescence intensity in the peripheral region (circles) of the cell and the fluorescence from the whole cell (triangles), and FIG. 27B shows the confocal microscope image of a single cell under partial penetration of the ferrotransferrin;

FIGS. 28A and 28B shows graphical plots of reflectivity variation in the SPR regime following the introduction of holo-Ferrotransferrin, in FIG. 28A the open circles indicate the results for the ZnS/Au/growth solution interface when there is no cell culture and the filled circles indicate a holo-Ft-induced reflectivity change from the ZnS/Au/Mel 1006/water interface, FIG. 28B shows that there is pronounced SPR blue shift that closely follows the kinetics of fluorescence from the peripheral parts of the cells;

### DETAILED DESCRIPTION OF THE INVENTION

A major challenge in modern pharmacology is to develop new experimental strategies for monitoring the dynamic interactions between molecules of biomedical significance and cognate targets in living cells. An important requirement for these techniques would be to provide sensitive and on-line monitoring of interactions while preserving the intactness of cells and tissues. In addition, as there is always a risk that labeling (e.g., by fluorescent, radioactive, or other chemical tags) can alter the physiological activity of the interacting ligand, it is desired to achieve label-free detection means capable of monitoring dynamic processes in living cells.

The present invention provides a surface plasmon resonance (SPR) technique in the near and mid infra-red which is based on a Fourier-Transform-Infra-Red (FTIR) source for monitoring dynamic processes in living cells. Heretofore, the majority of SPR measurements were limited to studying bio-recognition processes taking place on the surface of the film used as a substrate (i.e., in vitro), rather than in living cells themselves. As will be discussed and exemplified hereinbelow, the FTIR-SPR measurement scheme of the present invention is label-free and provides the sensitivity required for carrying out on-line monitoring of dynamic processes in living cells.

Unlike the conventional surface plasmon (SP) technique in the visible wavelength range, which operates at a fixed wavelength and a variable angle of incidence, the FTIR-SPR system of the present invention allows the wavelength (in the range between 0.8 and 12 μm) and the angle of incidence (generally in the range of 0°<θ<35° to be varied simultaneously. Accordingly, the present invention allows real-time and label-free measurement of small changes in the real and imaginary parts of the dielectric constant that occur in complex biological environments, such as cells, tissues, and fluids (e.g. human plasma) upon introduction of different molecules having biological activity. These changes in reflectivity, which are attributed to dynamic interactions between biomolecules and cells, are employed for monitoring cells activity.

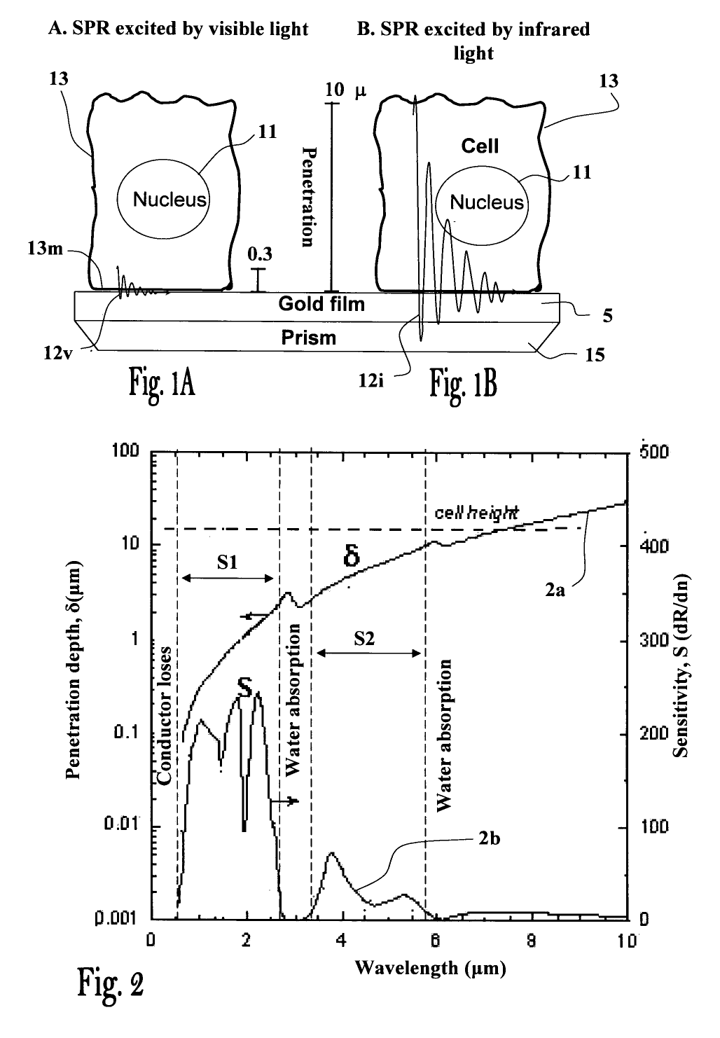

FIGS. 1A and 1B, comparatively illustrates SPR penetration depths in the visible wavelength range (12v) and in the infrared wavelength range (12i), and demonstrate that SPR excitation by mid-infrared radiation can sense the entire volume of cells 13. As shown, the SPR in the visible range (12v) is mostly sensitive to processes occurring near the cell plasma membrane region 13m that is in contact with the gold film 5, whereas the penetration of the SPR in the infrared wavelength range (12i) is significantly deeper and thus capable of sensing the entire volume cells 13.

FTIR-SPR has several important advantages over SPR in the visible range. Such as inter alia:
the SP waves travel at the metal/dielectric interface decaying exponentially in both directions perpendicular to the interface. Since the decay length is of the order of light excitation wavelength, the use of IR excitation allows deeper penetration of the SP wave (evanescent wave) and thus enables to monitor activities in much thicker biological films, of the order of 5-12 microns. This important feature allows the study of “thick” biological specimen such as whole living cells.
Infrared radiation, particularly within the 0.75-12 microns wavelength range, may excite various vibration/rotational modes in biological systems, which serve as unique ‘chemical fingerprints’ for identifying small changes in the complex biological systems. The detection sensitivity of the FTIR-SPR of these modes under SPR excitation conditions is very high due to the high signal enhancement.
SPR in the IR range exhibits extremely narrow angular width. For example, the angular width in the visible range (−600 nm) is larger by an order of magnitude compared to that in the near IR range (˜2 μm) and by factor of 30 compared to the mid-IR range (˜10.8 μm), which leads to a resolved angular spectra in the IR range that allow the identification of different spectral lines corresponding to different regimes of the sample (in particular, differences in cell densities, the existence of dense organelles e.g., nucleus (11), differences in cell's membrane composition, etc).
In addition, FTIR-SPR permits the performance of fast scans (on a sub-second time scale) as a function of wavelength and thus fits well to study dynamic biological processes, and since the SPR measurements require no labeling of the interacting components, it eliminates artifacts potentially introduced by molecular probe conjugation.
In contrast to the potential photo-damage that can be induced in the cell by the radiation with visible light, IR radiation level in FTIR-SPR measurements does not cause photo-damage to living cells.

Accordingly, due to its high sensitivity to substantially small changes in the refractive index, SPR in IR allows fast multi-wavelength measurements and thus allows the identification of biomolecules due to their specific absorption bands in the infrared (so-called “fingerprints”), and its relatively large penetration depth into the dielectric medium allows the performance of real-time measurements of interactions of biomolecules such as proteins, and drugs with living cells.

As seen in FIG. 2, showing penetration depth δ (curve 2a) and sensitivity S (curve 2b) curves as a function of the SPR wavelength, in the NIR wavelength range, the penetration depth of the SPR wave is substantially small (δ=½ kz=0.25 μm at λ=1.4 μm), thus limiting the ability of SPR to detect processes occurring close to cell-substrate contact sites. However, SPR measurements in the present invention utilize longer wavelengths in the mid-infrared (mid-IR 0.75-12 μm) range, and employing a FTIR source, enables deeper penetration (up to 12 μm) of the SP field into the cells, thus allowing sensing of dynamic processes taking place in significant portions of the cell, including regions of the contact-free plasma membrane. This relatively large penetration depth of the surface plasmon into a dielectric medium in the mid-IR range is also beneficial for studying cell cultures. Furthermore, as will be discussed and exemplified hereinbelow, by determining suitable parameters (wavelength, angle of incidence, conducting film thickness), the sensitivity of the SPR measurements may be substantially improved.

As shown in FIG. 2, the SPR penetration depth at the gold-water interface (δ, curve 2a) increases with wavelength. In the visible wavelength range, the penetration depth is too short (5-0.2 μm) for probing intracellular processes, while in the infrared wavelength the penetration depth is more or less comparable to the cell height (δ˜1-12 μm). It is further shown in FIG. 2 that the sensitivity of the SPR to variations of the refractive index of the biosolution (S, curve 2b) is limited, in the visible range—by conductor losses in gold, and in the mid-IR range—by the optical absorption in water, such that the highest sensitivity can be achieved when operating in the spectral windows S1 and S2, wherein the IR surface plasmon technique operates most successfully.

The SPR sensitivity S is limited by conductor losses and by absorption and scattering in the dielectric. In water, optical absorption in the visible range is low and the sensitivity of the SPR technique is limited by conductor loss in the metallic film. Silver is the best metal for the SPR technique in the visible range. In the infrared range, however, the situation is different. It was found that gold is the best choice for the metal substrate when operating with longer wavelengths λ>1.5 μm, although other metals, such as silver and copper may also provide satisfying results.

However, since the sensitivity of the SPR in the infrared range is limited by the dielectric losses in water, in order to achieve high sensitivity for a certain type of biomolecule (glucose for example), a suitable wavelength range should be determined where water absorption is not so high. The sensitivity of the SPR technique to small variations in the refractive index depends in a complicated way on conductor thickness d, the wavelength λ, the incident angle, Θ, and the average refraction index of the solution, nₛₒₗᵤₜᵢₒₙ, and therefore the determination of an adequately sensitive configuration represents a serious task.

One preferred method for determining an optimal combination of λ and Θ in order to achieve the highest sensitivity to glucose in water include the following steps: i) measuring reflectivity at the angle corresponding to the surface plasmon resonance using pure water as a sample; ii) measuring reflectivity spectrum for several angles and finding an optimal angle where the dip corresponding to the surface plasmon resonance is the deepest (the reflectivity achieves its minimum); iii) adding 0.3% D-glucose to the solution and measuring reflectivity spectra at the same angle; iv) plotting difference spectrum i.e. the difference between reflectivity of pure water and reflectivity of glucose solution at each wavelength, and finding at which wavelength the difference is maximal; v) repeating the same procedure for the angles that differ from the optimal one by 1-2°; vi) finding the angle and the wavelength where difference spectra achieves maximal values. These are the wavelength and the angle that have a highest sensitivity. A similar strategy can be applied to biomolecules other than glucose.

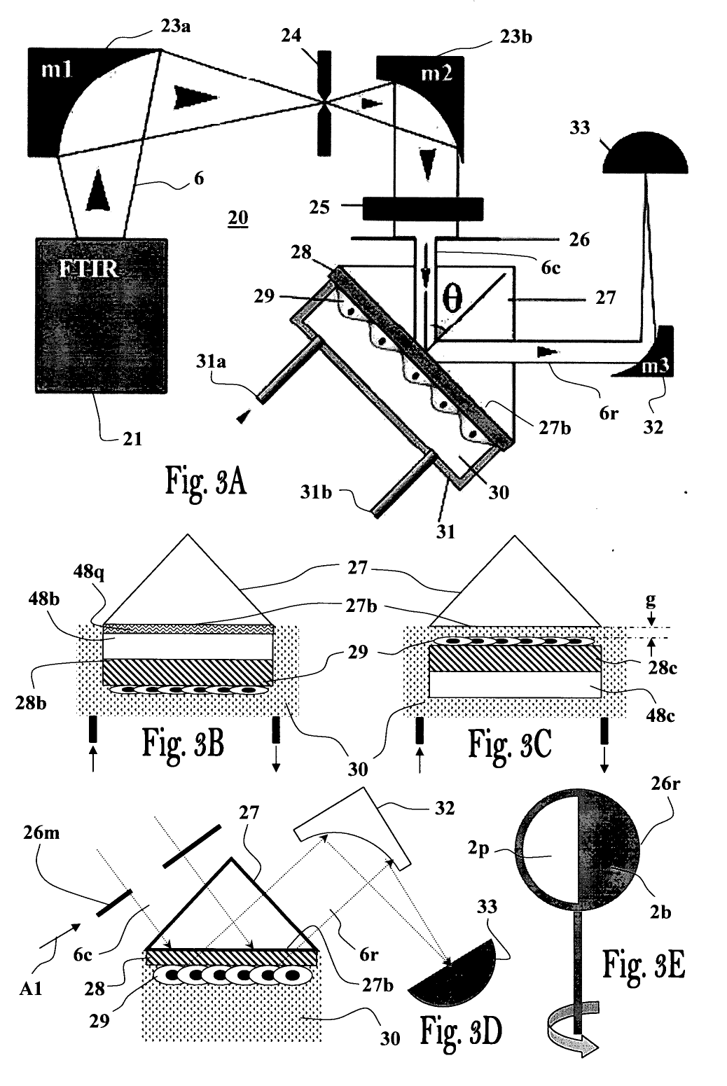

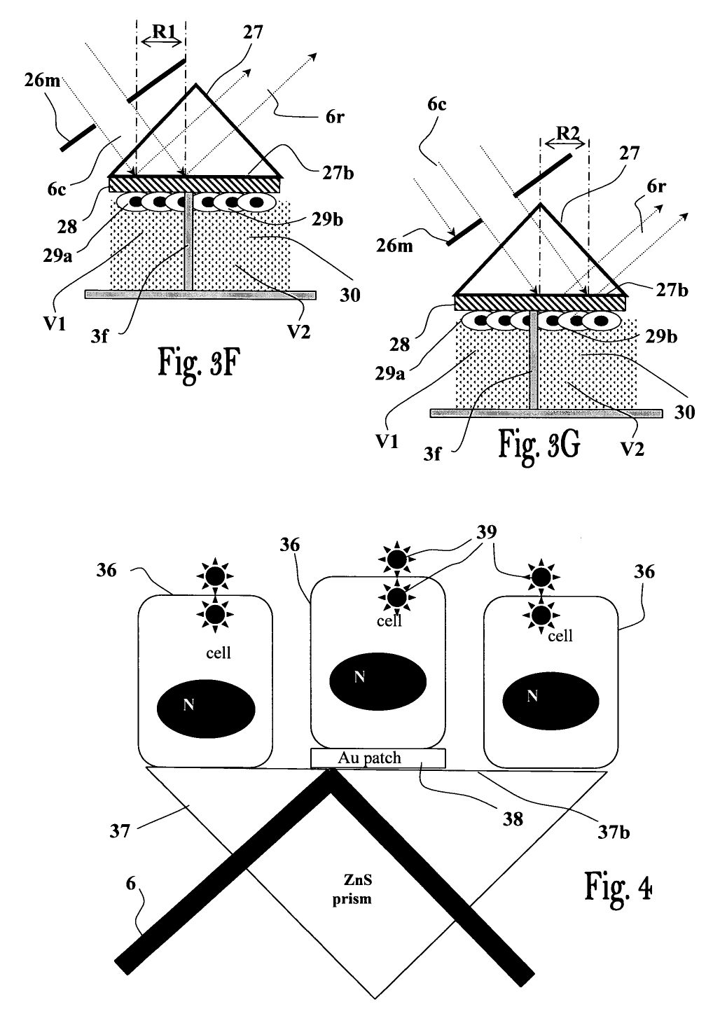

So far, the FTIR-SPR techniques have utilized glass-based optics that limited operation to the NIR range. The inventors hereof extended the FTIR-SPR technique to mid-IR range by using an improved FTIR-SPR setup based on the Kretschmann configuration. FIG. 3A schematically illustrates a MID-IR FTIR-SPR setup 20 according to a preferred embodiment of the invention, which is based on the Kretschmann configuration, comprising: an IR radiation source 21, a collimator 24, a prism 27 having a flow chamber 31 mounted over its base 27b, and an infrared detector 33 (e.g., liquid nitrogen cooled MCT detector), wherein the prism 27 and the IR detector 33 are mounted on a goniometer, and wherein the base 27b of prism 27 is coated with a layer of metal 28 (e.g., gold, silver, copper).

The MID-IR radiation source (21) may be implemented by a Bruker FTIR spectrometer (Equinox 55—Bruker Optik GmbH, Ettlingen, Germany), equipped with the KBr beam splitter, which is fully computer-controlled and can directly measure the SPR versus the wavelength at constant incident angles. The collimator 24 consists of a pinhole beam passage of about 1-mm in diameter mounted between two gold-coated off-axis parabolic mirrors 23a (m1) and 23b (m2) having a focal length of about 76.2 mm and 25.4 mm, respectively. The diameter of the collimated beam can be varied between 2 to 8 mm. After beam 6 produced by the FTIR source 21 passes through the collimator (24) and parabolic mirrors (23a and 23b) array, it is directed to prism 27 through grid polarizer 25 and iris 26.

While in the preferred embodiment described herein parabolic mirrors are employed it is noted that other such beam focusing means may be equally used, such as, but not limited to, focusing lenses, circular, elliptic or parabolic mirrors, Fresnel zone plates, or combinations thereof.

The prism 27 and IR detector 33 are preferably mounted onto a 0-20 Huber goniometer with an angular precision of ±0.0001°. For the NIR wavelength range prism 27 may be made from BK-7 or SF-11 glass, whereas for the mid-IR wavelength range, a ZnS or ZnSe prisms are preferable. Most preferably, prism 27 is a right angle ZnS prism having a surface area of about 10-40 mm². The base 27b of prism 27 is preferably coated by a metallic layer 28, preferably a gold film having thickness generally in the range of 8 to 50 nm (e.g., by means of electron-beam evaporation technique), preferably a bout 12 nm. Different thicknesses of metal film 28 may be chosen for achieving a desired sensitivity.

Flow chamber 31 is preferably a type of temperature-stabilized flow cell having a volume of about 0.5 ml and comprises an inlet 31a and an outlet 31b for allowing liquid 30 to be flown therethrough. Flow chamber 31 is attached to the base 27b of prism 27 such that the solution that fills chamber 31 is in direct contact with the gold coating 28. Preferably, base 27b is pressed onto flow chamber 31 with rubber seal by two M4 screws and Teflon hold-down bridge.

Living cells 29 of various types may be cultured directly on gold film 28. For, example, in one experiment HeLa cells were cultured routinely in Dulbecco's modified Eagle's medium (D-MEM, Biological Industries, Kibbutz Beit Haemek, Israel), supplemented with 4.5 g/l D-glucose, 10% antibiotics (stock solution: 10,000 units/ml penicillin, 10 mg/ml streptomycin, 0.025 mg/ml amphotericin, Biological Industries) and 10% fetal calf serum. A subconfluent cell monolayer cultured on a 10 cm plate was detached from the dish by treatment with trypsin C (0.05% Trypsin/EDTA in Puck's saline A; Biological Industries) and brought with growth medium to a density of 4×10⁶ cells/ml. A drop of 200 μl of the cell suspension was then placed carefully on the center of the gold-coated prism 27, previously mounted on the base of a sterile Pyrex glass beaker. Cells were allowed to attach for 30 min at room temperature. Thereafter, the beaker is filled with growth medium such that said medium slightly exceeded the level of the gold-coated surface of the prism. The cover of a sterile Petri dish is placed on top of the beaker and placed in a CO₂ incubator (5% CO₂, 37° C., 90% humidity). Cells are allowed to grow on the gold surface for 5-7 days.

Molecules with biological activity can access the cells cultured on the gold film 28 by injecting them into the flow chamber 31. The flow chamber 31 may be filled with growth medium 30 (“biomedium”) such that the cultured cells 29 may be maintained in close contact with the growth medium 30 throughout the entire course of the measurements. It is advantageous to arrange this setup (20 FIG. 1) in a horizontal configuration which prevents detachment of the cultured cells.

In operation, optimal operating conditions (incident angle, wavelength, and gold film thickness) are initially determined in order to achieve maximum sensitivity for a given measurement. Thereafter, flow cell 31 is filled with a solution that includes the biomolecules (e.g., glucose), and the reflectivity spectrum for the s-polarization is measured followed by corresponding measurements for the p-polarization. In these measurements the infrared beam 6 emitted from the external port of the spectrometer 21 is directed to parabolic mirror 23a which directs it to collimator 24. The beam is passed through the collimator 24 and then directed by parabolic mirror 23b to prism 27 mounted on a rotating table (not shown), through grid polarizer 25 and iris 26. The beam is reflected from the right-angle gold-coated ZnS prism 27 to another parabolic mirror m3 (32), which focus the reflected beam onto the liquid-nitrogen-cooled MCT (HgCdTe) detector 33 (may be mounted on a separate rotating table). In this way, the FTIR-SPR system 20 of the invention may be used for monitoring changes in the IR reflectivity as a function of time and thereby monitoring changes in the cells 29 cultured on the metal film 28.

The FTIR-SPR system 20 of the invention has a substantially high sensitivity to refraction index changes, e.g., 3·10⁻⁷ RIU at λ=2.5 μm. For example, the minimal concentration of D-glucose detectable in water by the SPR system of the invention was as low as 0.8 mM.

This system may be employed to perform SPR tomography to resolve different slices at different heights inside layers of cells (i.e. along the z-axis, perpendicular to the Au film).

This type of measurements preferably involves measuring the IR reflectivity at various wavelengths for each angle of incidence. The wavelength encodes the penetration depth, and with proper analysis, can be used to provide SPR information on slices at different heights above the metal film surface. This procedure may help to identify the location of the different molecules of life and organelles within cells.

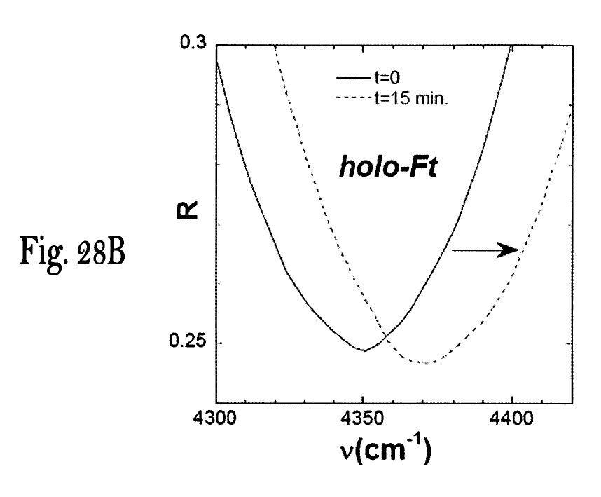

FIGS. 3B and 3C schematically illustrates embodiment of the invention based on the Kretschmann and Otto configurations, respectively, wherein the base 27b of prism 27 is not covered by a metallic layer and instead the cells 29 are cultured on a gold layer provided on a replaceable slide (48b in FIG. 3B and 48c in FIG. 3C). In the Otto geometry (FIG. 3C) replaceable slide 48c can be made from any suitable flat piece of material capable of being covered by a gold layer. In the Kretchmann's geometry (FIG. 3B) replaceable slide 48b should be made from the same, or a having very similar optical properties, material as prism 27, for example, ZnS or ZnSe, and it should be coupled using a thin layer of index-matching liquid 48q. All other elements of the measurement setup (20 e.g., beam processing means, focusing elements, etc.) remain unchanged. These configurations allow cultured cells to be examined by the SPR system of the invention on the metallic coat (28b in FIG. 3B and 28c in FIG. 3C) of the replaceable slides, and instantly replacing such slides having such cells cultures.

In the Kretchmann's configuration illustrated in FIG. 3B replaceable slide is preferably optically-coupled to prism 27 by introducing a thin index-matched liquid layer 48q between replaceable slide 48b and prism 27. For example, the prism and the slide can be made from ZnS or ZnSe, while the index-matching fluid 48q can be selected from Cargille Refractive Index liquids, Series B, M, H (Cargille Laboratories 55 Commerce Rd. Cedar Grove, N.J. 07009 USA).

As shown in FIG. 3C, in the Otto geometry the replaceable slide 48c comprising sample 29 is disposed adjacent to the base surface 27b of prism 27, such that the cells 29 are facing base 27b and a gap (g) is obtained therebetween. Advantageously, in this configuration replaceable slide 48b is not necessarily made from the low-loss IR material, such that it can be made from a simple glass and it can be opaque as well, the metal film can be thick (e.g., of about 10 nm to 10 microns, or even thicker), and the cells are detached from the prism and can be grown separately on these replaceable slides. Moreover, in the Otto configuration cells 29 are not necessarily in contact with the prism 27.

The Otto geometry shown in FIG. 3C is not used in conventional SPR implementations operating in the visible and Near-IR wavelengths ranges since in these wavelength ranges the optimal distance between the prism and the metal-coated surface should be on the order of 1 μm, which is too small, rendering this geometry impractical. However, the Otto geometry is much more practical in the infrared range due to the increased excitation wavelength. Due to the increased excitation wavelength in the IR wavelength range the distance (i.e., gap, g in FIG. 3C) between the prism and the metal-coated surface can be in the order few microns, or even 10-20 microns, which is feasible and provides suitable spacing for cells, which height is usually of about 6 microns.

Replaceable slide 48c can be prepared from glass, its surface area is preferably more or less the same as that of prism base 27b, and its thickness is arbitrary (for example, 1 mm).

FIG. 3D schematically illustrates an embodiment of the invention wherein a movable/rotatable shutter 26m is utilized for taking measurements from at least two different regions on the prism base 27b (also referred to herein as multichannel measurements). The measurement setup in this embodiment is substantially similar to that illustrated in FIG. 3A, (20 employing a fixed shutter 26), with the exception that here movable/rotatable shutter 26m is used for directing portions of the incident beam 6c to certain portions of base surface 27b of prism 27. For example, in case of a movable shutter, shutter 26m is moved in a plane (designated by arrow referenced as A1) allowing a portion of the incident beam 6c to pass therethrough.

In the visible wavelength range, such multichannel measurements may be easily obtained by means of a wide incident beam and CCD, or other multichannel detector means. Otherwise it would be a narrow incident beam (such as laser beam) and some scanning device. This strategy is not suitable for the infrared radiation due to inavailability, or very high price, of suitable lasers or CCD Arrays. Thus, in this preferred embodiment of the invention the incident (6c), or reflected (6r), beam is split into two parts for obtaining measurements either in parallel, by using two detectors (not shown), or sequentially, by using movable (26m) or rotatable shutter (26r) that partially blocks the incident (6c) or reflected beam (6r).

FIG. 3E schematically illustrates a rotatable shutter 26r comprising light passing portion 2p and light blocking portion 2b, such that portions of the incident beam (6c) can be directed through light passing portion 2p to certain portions of base surface 27b of prism 27 by rotating rotatable shutter 26r by 180°.

FIGS. 3F an 3G schematically illustrates an embodiment of the invention in which the volume of the flow cell is divided by partition 3f into two separate compartments, V1 and V2, such that the cultured cells (29) are also divided into two groups, 29a and 29b, respectively. As shown, in this setup measurements of beam 6r reflected from a portion R1 of prism base 27b corresponding to the group of cells 29a in V1 are taken in a first state of movable shutter 26m shown in FIG. 3F, and measurements of beam 6r reflected from a portion R2 of prism base 27b corresponding to the group of cells 29b in V2 are taken in another state of movable shutter 26m shown in FIG. 3G.

This configuration allows performing multichannel measurements simultaneously, or in series with small time lapse, in two different parts of the sample (29a and 29b). This embodiment is useful for studying the effect of drugs on cells, for example, by defining a control group of cells (cells that were not treated with drugs e.g., 29b in V2), such that one part of the cell layer (29) can be used as a control group and another part (e.g., 29a in V1) as a sample group under study.

While prism 27 exemplified hereinabove is a traditional prism i.e., a transparent optical element having light refracting surfaces (e.g., triangular or trapezoid prism), it may also be implemented by means of an optical fiber having an obliquely cut end coated with a thin metal film (also having internal reflection), such as described by Knoll [Annu. Rev. Phys. Chem. 1998. 49: 569-638], or using the optical fiber configurations: polished-end fiber-SPR; micro-prism fiber-SPR; or cladding-removed fiber-SPR, described by Hoa et al., [Biosensors and Bioelectronics 23 (2007) 151-160]. Other suitable optical fiber setups were described by: Ikehata et al., [Anal. Chem. 2004, 76, 6461-6469]; Homola [Anal Bioanal Chem (2003) 377: 528-539]; and Slavik et al., [Sensors and Actuators B 74 (2001) 106-111].

The measurements can be carried out at single wavelength using a laser, or another narrow-band source, or alternatively, the measurements can be carried out using a wideband source such as incandescent lamp The measurements can be carried out using a wideband source and detection at several wavelengths (i.e., measuring reflectivity at different wavelengths), for example using an FTIR apparatus which allows detection at several wavelengths using a single detector.

It should be noted that the light beam (6r in FIG. 3A) reflected from prism 27 is not obtained as a full internal reflection from the base 27b, but rather at an angle that corresponds to the excitation of surface plasmon wave, that can propagate along the metal film. Hence at some angle corresponding to the excitation of the surface plasmon wave, the reflectivity will be minimal instead of maximal (as it should be under total internal reflection).

In one specific preferred embodiment of the invention, illustrated in FIG. 4, micron-scale gold patches 38 are placed on the base 37b of prism 37. The precise size of the patches 37b (e.g., having a surface area between 0.05×0.05 to 0.2×0.2 mm² and thickness in the range of 8-50 nanometers) is determined upon their ability to produce an SPR signal that can be sensitively detected by the FTIR-SPR system. Generally, it is assumed that gold patches on the order of ˜100 μm size are capable of contributing a detectable SPR signal. The thickness of the gold film in the patches should be determined to match the condition for the observation of the SPR minima. The living cells 36 are cultured directly on the surface of gold patches 38 in the same way as they are grown on the continuous gold film. This embodiment allows detecting clusters of cells 36, cultured on the patches 38. Although the beam size is larger than patches 38, reflectivity minima associated with SPR can be observed only from patches 38. Furthermore, lateral (x-y) scanning at each angle is essential for studies of a single patch. The lateral SPR resolution allow the detection of processes taking place in a small cluster of the cultured cells.

Infrared radiation, particularly in the 2-12 micron range, may excite various vibrational/rotational modes in organic molecules. These modes, which are detected in IR transmission spectra, can be identified as unique “chemical fingerprints”. Tuning of the SPR to this spectral range allows identification of specific absorption bands in the infrared (i.e. “fingerprints”), as a signature characterizing the specific molecule. Although the “fingerprint” may depend on the surrounding of the molecules, it principally allows sensitive detection of molecules by label-free means (without any additional tagging), inside complex biological systems, such as cells, tissues and fluids (e.g., blood plasma).

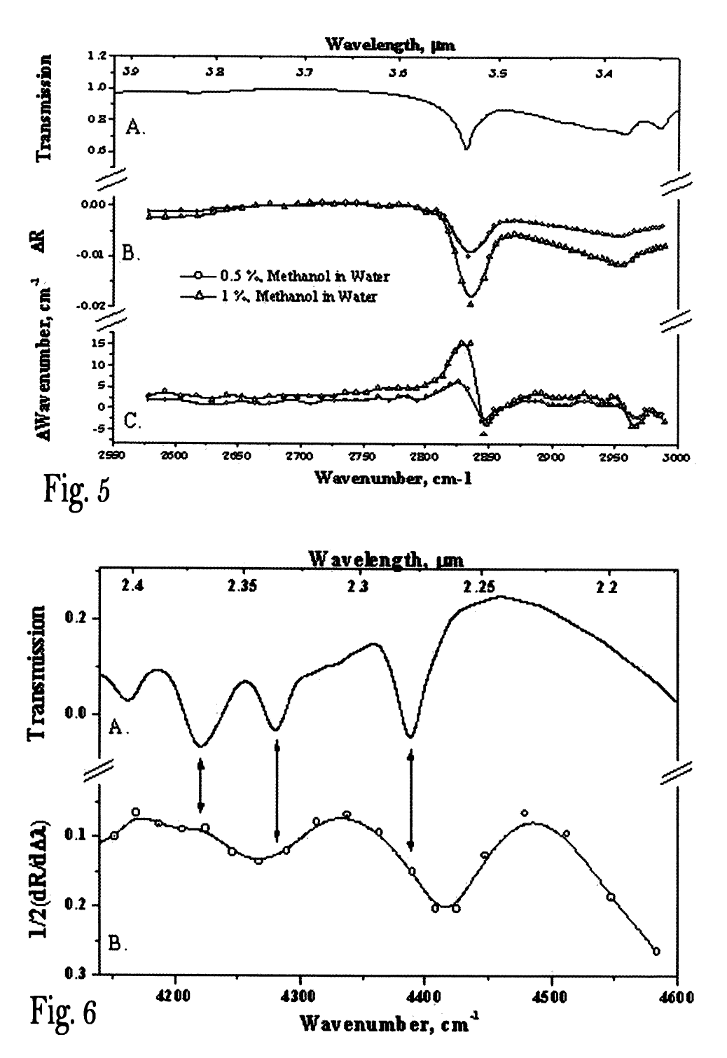

Specificity of detection by SPR-fingerprints is demonstrated in FIGS. 5 and 6. FIG. 5 shows a computer simulation for fingerprint detection, wherein curve A represents a transmission spectrum of pure methanol, and curves B and C are numerical simulations of methanol fingerprint detection by SPR in mid-infrared. FIG. 6 shows experimental data of glucose fingerprint detection, wherein curve A shows a fingerprint at 3.3 μm, observed experimentally by FTIR transmission spectroscopy through dry D-glucose, and curve B shows the experimental result of SPR reflectivity measurement for a 0.3% (w/v) solution of glucose in water.

FIG. 6 represents the derivative of the wavelength shift of the SPR minima at various angles of incidence. A fingerprint at 3.3 μm is observed experimentally by FTIR transmission spectroscopy through a dry D-glucose in curve A. Curve B shows the experimental result of SPR reflectivity measurement for 0.3% (w/v) of glucose in water. The correlation between curves A and B in FIG. 6 shows the ability of the method to sensitively detect small concentrations of specific molecules in solution by comparing SPR and spectroscopy methods. Therefore, the SPR measurement technique in the mid-infrared of the invention may be employed to reveal fingerprints in a variety of molecules with specific biological activities.

A numerical simulation may be used for each specific biomolecule to optimize incident angle, wavelength, and gold film thickness in order to achieve maximum sensitivity as well as measurement capability up to a certain level of biomolecule solution concentration. The simulation may comprise the following steps:
1. Calculation of the real and imaginary parts of the refractive index as a function of the biomolecule concentration.
2. Calculation, using Fresnel reflectivity formulae, of the beam reflectivity as a function of wavelength and incidence angle for a film of certain thickness.
3. Identifying wavelength and incidence angle of maximal sensitivity, determination of the possible concentration sensitivity, the upper concentration range, and thus also the measurement dynamic range.

In one embodiment, the simulation is used in the measurement design phase. In another embodiment, the simulation is used for the measurement analysis phase.

For example, the design considerations for a glucose-water solution to be used in a system having an optimal 12 nm thick gold film, may involve:
consideration of SPR sensitivity in view of conductor losses and absorption and scattering in the dielectric. The imaginary part of the SP wave vector fulfills kₛₚ″=εₘ″/[2(εₘ′)²] where εₘ′ and εₘ″ are real and imaginary parts of the metal dielectric constant. The dielectric constant of the gold is ε_{Au}=−238.8+i 37.35 at λ=2.48 μm and ε_{Au}=−9.895+i1.05 at λ=0.652 μm. The conductor loss in the infrared is low, kₛₚ″=0.00033 μm⁻¹ at 2.48 μm, compared to kₛₚ″=0.0054 μm⁻¹, at 0.652 μm. Since, the sensitivity of the SPR technique in the infrared range is limited by the dielectric losses in water, in order to achieve high sensitivity for a glucose-water solution one should carefully choose a wavelength range where water absorption is not too high; and
consideration of the refractive index of the glucose-water solution. The real and imaginary parts of the refractive index n+ik of pure water and dry glucose may be examined. These refractive indices may be calculated based on the data of Palik, Handbook of Optical Constants of Solids II (Academic Press, Inc., 1991) and by Jetzki and Signorell (J. Chem. Phys. 117, 8063-8073, 2002). It should be noted that across the 0.75 to 10 μm wavelength range, the water absorption is high, compared to that of glucose. Therefore, absorption spectroscopy is inefficient in measuring glucose in water. However, due to the large differences in the real part of the refraction indices of water and glucose, especially in the range of 2.5-3 μm, by measuring the difference in the real part of the refraction indices of pure water and of the water-glucose solution, the glucose concentration may be measured.

In case of glucose solution: In the first step of the simulation, the complex refractive index over a wavelength range of 0.75-12 μm is computed based on effective-medium approximation (Landau, Lifshitz and Pitaevskii, Electrodynamics of Continuous Media, Butterworth Heinneman, 2002); In the second step of the simulation, the reflectivity of the ZnS/Au/water interface, R_{water} is calculated as a function of the wavelength and incident angle, and similarly the reflectivity Rₛₒₗᵤₜᵢₒₙ for 0.3% glucose solution is also calculated; In the third step of the simulation, it is realized that in the limit of small concentrations, c<83.3 mM (millimolar), the calculation yields a linear dependence on concentration, in particular, at 2.5 μm, wherein refractive index is n=1.25+4.2·10⁻⁵·c. By analyzing the reflectivity difference, ΔR=R_{water}−Rₛₒₗᵤₜᵢₒₙ, it is realized to be most pronounced for θ=22° and λ˜2.0-2.7 μm. Taking the whole spectral line, or feature, into account, rather than a single wavelength, the sensitivity improves and at a fixed incidence angle of θ=22°, the minimal measurable glucose concentration is 0.8 mM. On the other hand, when the average refraction index of the solution deviates from that of pure water by more than 0.5%, the sensitivity decreases by a factor of two, and thus measuring the glucose concentration in water according to this procedure is limited to 50 mM. Together with the above value of 0.8 mM for minimal concentration, the dynamic range of the SPR technique for glucose-water solution is thus well defined.

The FTIR-SPR technique of the invention may be used for: identifying and monitoring dynamic changes taking place in intracellular organelles having distinct refractive indices, such as the nucleus; monitoring alterations in cell dimensions (volume) occurring in response to various treatments (e.g., exposure to drugs, etc.); revealing chemical fingerprints in biological compounds (e.g., molecules/drugs with biomedical implications), thus allowing specific and sensitive detection of the presence of organic molecules in the context of complex environments (e.g., glucose within human plasma).

Some of the advantages achieved by mid-infrared FTIR-SPR technique of the present invention are:

1) Fast multi-wavelength measurements: The ability to detect SPR at varying wavelengths and/or varying angles, allows “tuning” the surface plasmon resonance to any desired spectral range in order to achieve the highest sensitivity.
2) Fast scanning: FTIR-SPR permits the performance of fast scans (on a sub-second time scale) as a function of wavelength, and thus is well suitable for studying dynamic biological processes.
3) Spectroscopy. Since many biomolecules have specific absorption bands in the infrared (so-called “fingerprints”), performing multiwavelength SPR measurements in the spectral range of fingerprints, in principle, allows these biomolecules to be identified selectively.
4) Penetration depth (FIG. 1): The penetration depth of the SP wave increases corresponding to increasing of the wavelength. The SPR penetration depth at the visible range (e.g., device of Biacore) is restricted to about 0.3 μm, therefore, it can probe only limited volumes proximal to the gold layer and cannot penetrate into the cells. The mid-infrared SP wave can penetrate up to ˜12 microns into the dielectric layer adjacent to the gold layer, i.e., it can penetrate the whole volume of cells. Therefore, SPR measurements in the mid-infrared can provide useful information on the dynamic interactions between biomolecules and cell components located even far-off the gold layer. It can be principally used to sense dynamic changes with sensitivity to the entire cell volume of most living cells, and possibly of thin organ sections.
5) Photo-damage: In contrast to the potential photo-damage that can be induced by radiation in the visible range, mid-infrared radiation does not cause photo-damage in living cells, and is therefore highly suitable for conducting measurements on biological specimen.
6) Angular width: SPR in the infrared range exhibits extremely narrow angular width. For example, the angular width of the SPR in the visible range in air (˜600 nm) is larger by an order of magnitude compared with that in the near infrared (˜2 μm), and by factor of ˜30 compared to the mid-infrared range (˜10.8 μm), [Lirtsman, V. et al., “Surface-Plasmon-Resonance with infrared excitation: studies of phospholipid membrane growth”. J Appl Phys 98:Art. No 093506, 2005]. The narrower angular width may increase significantly the sensitivity of the SPR detection.
7) High sensitivity. Since conductive losses in the infrared range are lower than those in the visible range, the infrared SPR can be more sensitive than its visible range counterpart.

By way of example, the apparatus and method of the current invention may be inter alia used for:
1) measuring delicate changes in low, even sub-physiological, glucose concentrations in water.
2) measuring glucose uptake by red blood cells.
3) monitoring uptake of human transferrin by human melanoma cells.
4) identifying and monitoring dynamic changes taking place in intracellular organelles having distinct refractive indices, such as the nucleus.
5) monitoring alterations in cell dimensions or volume occurring in response to various treatments like exposure to drugs.
6) analyzing glucose uptake in cells expressing predominantly GLUT-1.
7) monitoring glucose uptake by cells expressing the glucose transporter GLUT-4 in response to insulin stimulation.
8) monitoring ligand uptake into living cells in real-time.
9) measurements of lipids and lipophilic drug incorporations into the plasma membrane (PM) of living cells for studying drug absorption, and/or for studying the structure-function relationships of membranes by manipulating its lipid and protein content. In such applications the SP wave produced in the IR wavelength range is employed for sensing with substantially high sensitivity alterations in refractivity occurring particularly in the PM that is in contact with the Au-layer. However, due to the longer penetration depth, it should also sense alterations in refractivity taking place in some of the contact-free PM. This implementation of the SPR technique of the invention is demonstrated herein below utilizing the FTIR in the near-IR for monitoring cholesterol removal and insertion into the plasma membrane of living cells, as well as into an artificial monolayer of immobilized phospsholipids. Of course, this implementation may be extended to the monitoring of other lipophilic drugs.
10) Measuring the degree of surface occupancy by cells (or by other materials immobilized on the Au surface), due to the fact that under specific measurement conditions (i.e., angle of incidence, and wavelength), the FTIR-SPR in the IR can detect empty and cell-occupied regions on the gold surface. This implementation may be used for measuring the adherence strength to the gold film. Various means to tightening cell adherence to the Au substratum (e.g., by fibronectin and RGD-based peptide coatings) may be applied, as well as means causing cell loosening and detachment.
11) Measuring endocytic vesicle formation in living cells. This rather surprising capability of the FTIR-SPR of the invention in the mid-IR is found to be important, particularly in the pharmaceutical area which seeks for quantitative and real-time monitoring of protein and other hydrophilic compounds, which enter cells via endocytosis. Additional cases that could be monitored using this implementation are the endocytosis of proteins (e.g., epidermal growth factor), and even viruses and bacteria which enter the cells via endocytosis and phagocytosis, respectively.
12) Measurements of drug uptake by cells. In view of the promising data obtained on the monitoring of glucose uptake by human erythrocytes, which may provide a ‘proof of principle’ for monitoring of other biologically-active drugs, it is believed that drugs which traverse the plasma membrane and accumulate in the cytoplasm can be monitored by FTIR-SPR in the IR. Since the SPR technique of the invention may be used for sensing specific chemical present within a complex (mixture) biochemical environment based upon their SPR-fingerprints, it is expected that it will also enable the monitoring of a specific drug in a complex biochemical environment (which includes other chemicals and cells) based upon its unique SPR fingerprints detection.
13) Detection of a wave guide mode. It was found that tight cell monolayers cultured on the Au film can conduct a wave guide. This phenomenon may be exploited for measuring various cellular parameters, among which is cell monolayer thickness (height). Since obvious techniques for measuring this parameter in living cells and in real-time were not reported, it may be important for studying the functions of the cytoskeleton, cell transformation, cell division, cell responses to various environmental changes (ionic strengths, pH, exposure to drugs) etc.
14) Cell-cell interactions. The long penetration depth of the SPR in the mid-IR is ideal for detecting the interactions of “bulky” biological entities, such as other cells, with target cells attached to the Au substratum (see attached Figure). This technique may be further employed for studying bacterial-cell interactions, as well as interactions between cells in the immune system (e.g., Natural Killer (NK) cells) and target infected cells.

The FTIR-SPR system of the invention was employed to demonstrate: 1) delicate changes in low (even sub-physiological) glucose concentrations in water; 2) glucose uptake by red blood cells and 3) uptake of human transferrin by human melanoma cells. In some of these experiments, the experimental data was simulated by computations assuming a certain model of the interaction between introduced biomolecules and cells.

In conclusion, the newly developed FTIR-SPR technique allows fast, real-time, and label-free detection of the dynamic interactions between specific biomolecules and complex biological entities, such as living cells. The technique can be advantageously applied in the x-y-scanning mode as well. The FTIR-SPR system of the invention is able to detect clusters of cells, and by increasing its sensitivity, for example by analysis of a full fingerprint feature it, may be used to detect and monitor a single cell.

The FTIR-SPR system of the invention may be implemented to monitor quantitatively in real time the dynamic interactions between biomolecules and their cognate receptors in cells, and to sense the interactions between cells and biomolecules whose dielectric properties facilitate their sensitive detection. Another implementation of the invention is for studying drug delivery and clearance (including drugs used in chemotherapy, antibiotics, etc), ligand-receptor and pathogen (viruses and bacteria) cell interactions.

Other implementations of the FTIR-SPR system of the invention may be used for monitoring and diagnosing diabetic states. Additionally, it may be further extended to study the dynamics of interactions of various small and large biomolecules, including drugs toxins and pathogens, with cells. In particular:

1) To measure quantitatively the dynamic interactions between simple, and complex biomolecules (of small molecular weight such as glucose and drugs, and larger, such as proteins and viruses) with living cells in vitro, and with tissues in vivo.
2) To monitor quantitatively the dynamic interactions between cells, for example cell-cell interactions in the immune system.
3) To identify and monitor dynamic changes of intracellular organelles having distinct refractive indices, such as the nucleus.
4) To monitor quantitatively cell adherence to extracellular substrata, and the degree of surface occupancy by cells.
5) To monitor alterations in cell dimensions (volume) occurring in response to various treatments (e.g., osmotic changes, exposure to drugs, etc.)
6) To reveal chemical fingerprints in biological compounds, which will enable specific and sensitive detection of the presence of organic molecules in the context of complex environments, such as glucose within human plasma.
7) by increasing the resolution of the technology, for studying dynamic processes occurring within single cells and thereby to detect responses taking place by single cell, or clusters of a few cells.

### EXAMPLES

### Example 1

Real-time monitoring of transferrin-induced endocytic vesicle formation

### Experimental Setup

Surface plasmon (SP) was excited using Kretchmann's geometry as illustrated in FIG. 3A employing the Bruker FTIR spectrometer (Equinox 55—Bruker Optik GmbH, Ettlingen, Germany) equipped with a KBr beam splitter as mid-IR source, and a right-angle ZnS prism having a 20×40 mm base (ISP Optics, Inc., Irvington, N.Y, US) coated with an 18-nm-thick gold film (electron-beam evaporation). Cells were cultured on the gold surface, as described below. The prism and cells were attached to a flow chamber mounted on a goniometer, in such way that the cells on the gold-coated base faced the flow chamber's volume (0.5 ml). The flow chamber was filled with cell culture medium, resulting in direct contact between the medium and the gold layer, or cells cultured on that layer. The medium was passed through the chamber at a constant flow rate (5 μl/min) during the entire experiment, using a motorized bee syringe pump equipped with a variable speed controller. The temperature of the medium flowing through the chamber was controlled (±0.1° C.). The infrared light from the output window of the FTIR instrument passed through a collimator, consisting of a 1-mm diameter pinhole mounted between two gold coated off-axis parabolic mirrors, m1 and m2, with focal lengths of about 76.2 mm and 25.4 mm, respectively, along with a grid polarizer and an iris. The collimated beam (˜4 mm in diameter) was reflected from the ZnS prism and focused by an additional parabolic mirror, m3, onto a liquid-nitrogen-cooled MCT (HgCdTe) detector, mounted on the goniometer.

### Cell Culture and Preparation for SPR Measurements

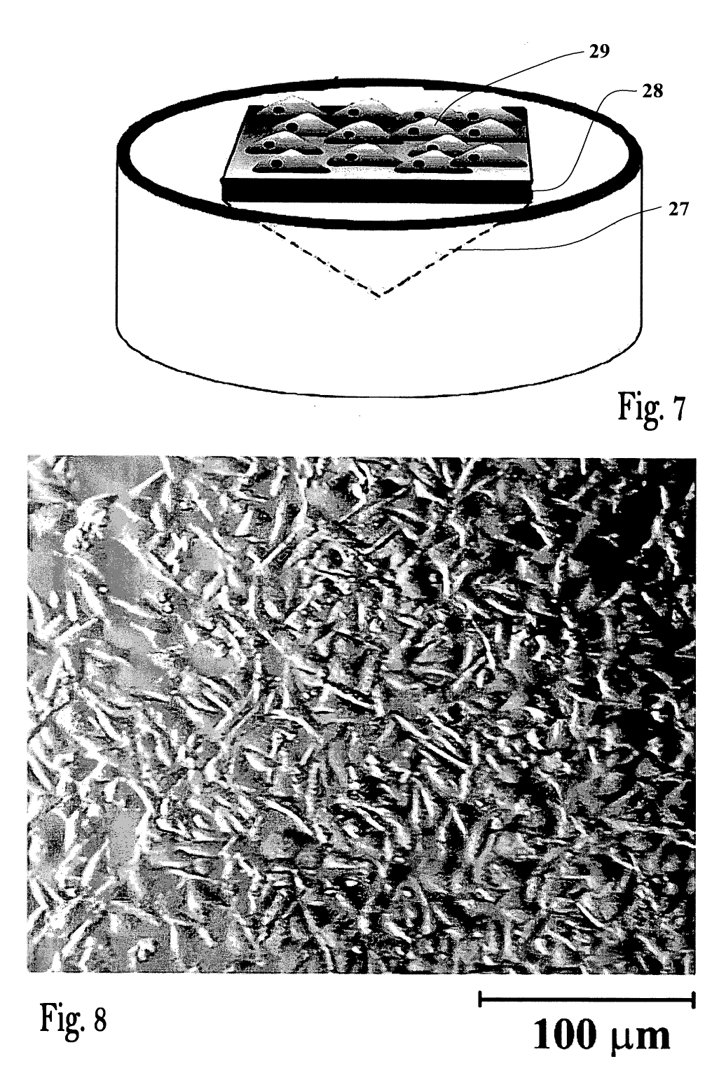

Human melanoma (MEL 1106) cells were cultured on a 10-cm dish in Dolbecco's modified Eagle's medium (D-MEM, Biological Industries, Israel), supplemented with 4.5 g/l D-glucose, 10% antibiotics, and 10% fetal calf serum, as previously described for HeLa cells [Ziblat et al., 2006]. These cells were used in the SPR experiments, and their culture on Au coated prisms was performed as follows: upon reaching 70% confluence, cells were detached from the dish by trypsin C (0.05% Trypsin/EDTA in Puck's saline A; Biological Industries, Israel) treatment, and brought to a cell density of about 1.8×10⁵ cells/ml in complete growth medium. With reference to FIG. 7, three milliliters of cell suspension 29 were seeded on top of the Au-coated ZnS prism 27 mounted onto a home-made polycarbonate holder, such that the cell suspension 29 covered the entire prism's base 28. Cells were allowed to attach for at least 3 hrs in a CO₂ incubator (5% CO₂, 37° C., 90% humidity). Thereafter, growth medium (5 ml) was added and the prism 27 was placed in a CO₂ incubator for an additional 2-3 days, until a uniform and nearly confluent monolayer of cells (above 70%; ˜30 cells per 1000 μm²) covered the Au-surface. FIG. 8 shows a typical optical micrograph (imaged with a Zeiss Axiotech vario 100 HD microscope) of a MEL 1106 cell monolayer cultured on an Au-coated ZnS prism 27 used in the SPR experiments.

### SPR Measurements and Analysis

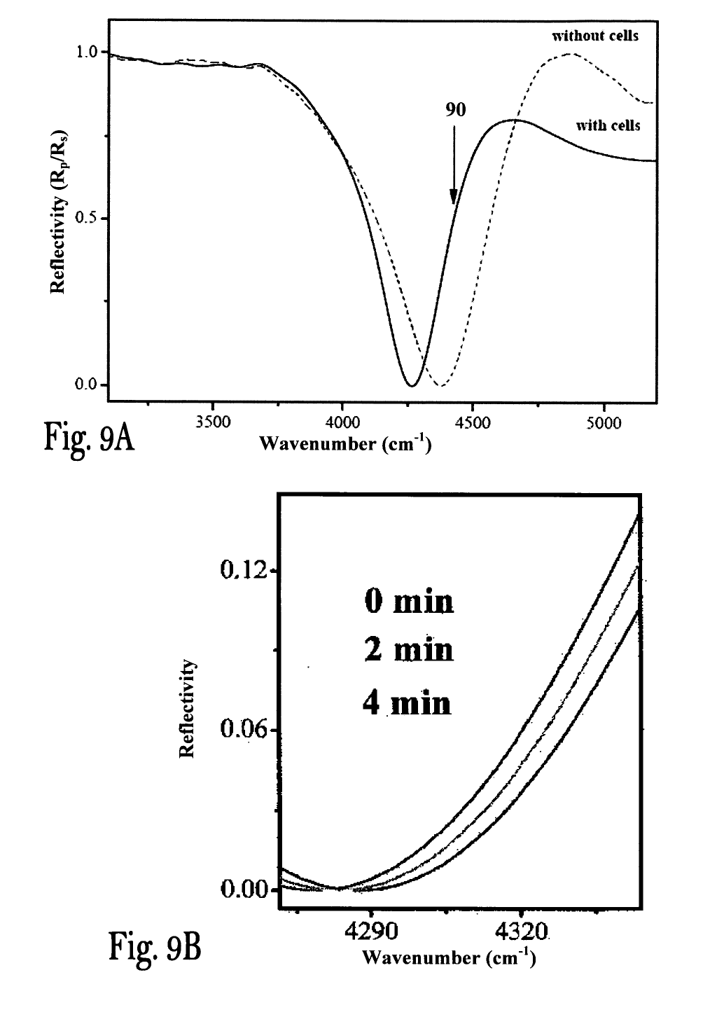

In the initial phase of each experiment, cells cultured on an Au-coated prism were exposed to serum-free DMEM for 3 hours at ° C. for depleting the cells from internal pools of Tfn contributed by the serum. The prism with the cultured cells was then attached to the flow chamber, which was rapidly filled with pre-warmed (37° C.) minimal essential medium (MEM) containing Hank's salts (GIBCO), 20 mM Hepes, pH 7.2, and 5 μg/ml BSA (MEM-BSA). The temperature in the flow chamber was adjusted to 37° C.±0.1° C., unless otherwise indicated. Thereafter, the angle of incidence in the SPR configuration was set to θ=35.5°. As can be seen in FIG. 9, measurements at this angle yielded an SPR reflectivity minimum at λ=2.34 μm (4280 cm⁻¹). These parameters were optimal, allowing maximal sensitivity (S=ΔR/Δn), and reasonable SP penetration depth/propagation length.

The reflectivity of the s-polarized beam was used as a background for subsequent measurements. The SPR signal is the ratio of the reflectivities obtained for the p-polarized and s-polarized beams. The FTIR-SPR set-up of the invention repeatedly measured the reflectivity spectra. This was done every 25 seconds with a 4-cm⁻¹ wavenumber resolution and with 16-scan averaging. The SPR measurements were carried out continuously for 15-20 minutes, until a stable SPR signal was recorded. MEM (2 ml) containing the ligand (5 μg/ml of Tfn) was injected into the flow chamber at a constant flow rate (5 μl/min) without interrupting the SPR measurements, for 20-30 min. At the end of each experiment, the prism was examined under the microscope for cell monolayer integrity.

FIG. 9A shows the SPR signal of an Au-coated prism, with (a solid line) or without (a dashed line) cells. The presence of cells shifts the SPR minimum to a longer wavelength. Representative SPR signals obtained for melanoma cell monolayers exposed to holo-Tfn at 37° C. and monitored at three different time points are presented in FIG. 9B. The reflectivity minimum, R, shifts towards shorter wavelengths over time. All subsequent results are presented as changes in reflectivity over time [ΔR|ν=R(t0)|ν−R(t)ν], measured at a specific wavenumber (ν) of 4425 cm⁻¹ (90 in FIG. 9). An was calculated using the expression: Δn=ΔR|ν/S(ν), where S(ν) is defined as sensitivity to refractive index changes (S(ν)=δR/δn), S(ν=4425 cm-1)=80 RIU⁻¹.

### Preparation of Holo and Apo-Tfn

sHuman apo-Tfn (Biological Industries Co., Beit Haemek, Israel) was loaded with iron as described by Podbilewicz et al., [(1990) ATP and cytosol requirements for transferrin recycling in intact and disrupted MDCK cells. Embo J 9, 3477-87] that converts it to holo-Tfn. The apo-Tfn was extensively dialyzed against 35 mM sodium citrate, pH 5.0, to remove possible iron traces from the commercial product. The protein was then dialyzed against 20 mM Hepes, 150 mM NaCl, pH 7.4, and used as apo-Tfn in the SPR experiments. All samples were aliquoted and frozen at −70° C.

### Preparation of Lissamine Rhodamine Apo-Tfn

Apo-Tfn was tagged with Lissamine Rhodamine (Sulforhodamine B sulfonyl chloride), as described by Sohn et al., [(2008) Redistribution of accumulated cell iron: a modality of chelation with therapeutic implications. Blood 111, 1690-9]. Briefly, human Apo-Tfn (4 mg/mL dissolved in 25 mM Na₂CO₃, 75 mM NaHCO₃, pH 9.8), was incubated at 5° C. overnight with 1 mM lissamine rhodamine sulfonyl chloride (Molecular Probes, Eugene, Oreg.), and the labeled protein was isolated by gel filtration on Sepharose G25 (Sigma-Aldrich) pre-equilibrated with 150 mM NaCl, 20 mM MES, pH 5.3. The sample was then dialyzed against Hepes buffer, and aliquots were stored at −20° C.

### Time-Lapse Imaging of Fluorescently Tagged-Tfn Uptake

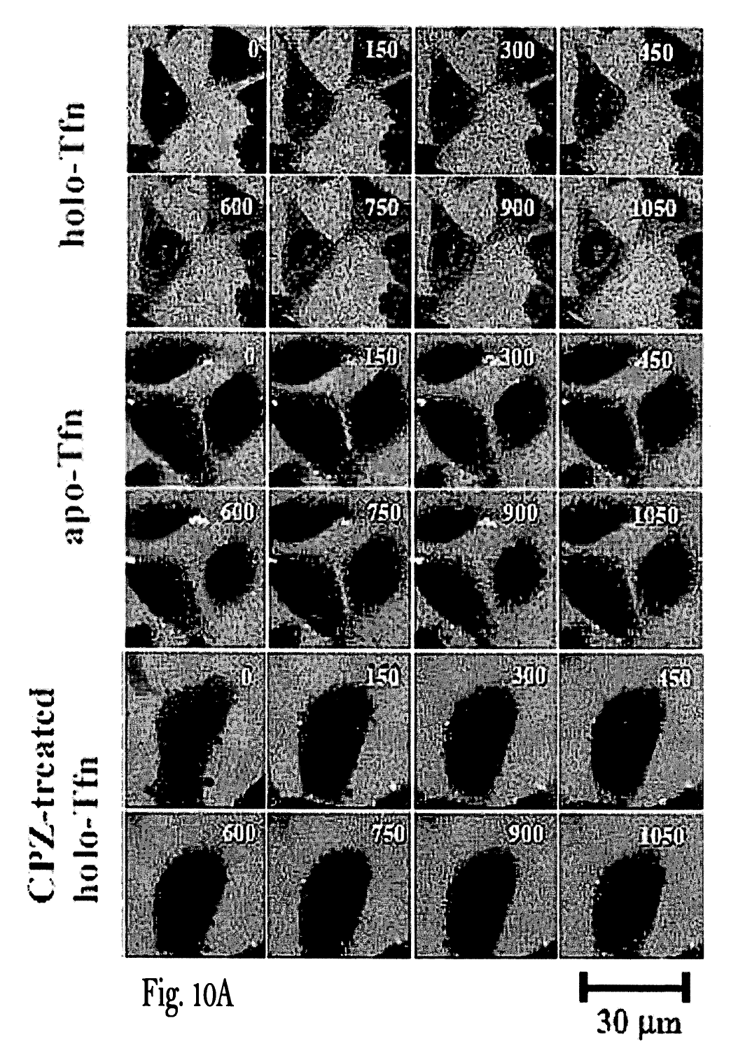

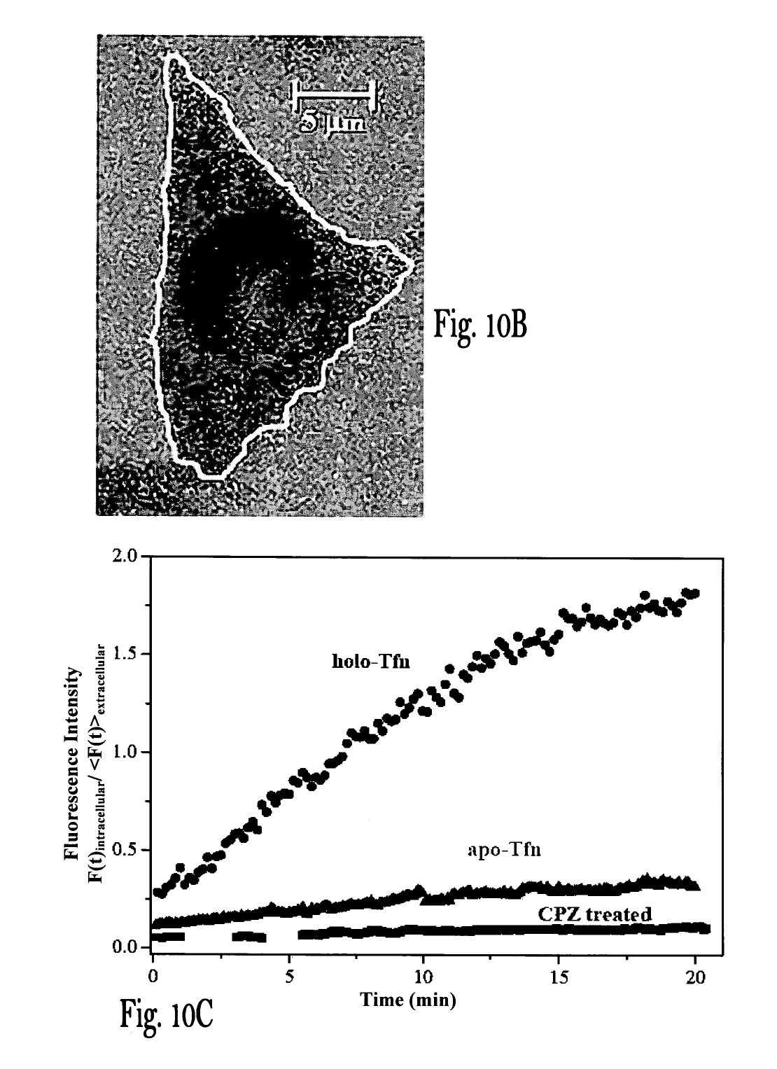

Melanoma cells were cultured to ˜50% confluence on glass bottom culture dishes (35 mm dish, 14 mm Microwell; MatTek, Co., MA, USA). Cells were first exposed to growth medium lacking serum for 3 hrs prior to the experiment, and then washed three times with internalization buffer (150 mM NaCl, 20 mM Hepes, pH 7.4, 1 mM CaCl₂, 5 mM KCl, 1 mM MgCl₂, 10 mM Glucose). Following the last wash, internalization buffer containing 0.1 μM sulforhodamine green (SRG) (Biotium, Hayward, Calif.) was added to the medium. Cells were imaged (FIG. 10A—confocal imaging of live cells performed simultaneously in the green and red channels, about 30 sec (designated time 0) after cell exposure to the ligand) with an Olympus FV-1000 confocal microscope equipped with an on-scope incubator (Life Image Services, Bazel, Switzerland), which controls temperature and humidity, and provides an atmosphere of 5% CO₂. A 60×/NA=1.35 oil immersion objective was used. Since the anionic SRG does not enter intact cells, the cells appear as dark objects against a uniform fluorescent background when imaged with the confocal microscope. First, one plane of focus was acquired, and Rhodamine Red'-holo Tfn (5 μg/ml; Jackson ImmunoResearch) was introduced into the imaging buffer. Confocal images of both the SRG (Ex: 514 nm; Em: 535-565 nm) and Rhodamine Red-holo-Tfn (Ex: 543 nm; Em: 560-660 nm) were acquired from the same section every 10 or 20 sec. A similar protocol was used for Lissamine Rhodamine-apo-Tfn, except that the SRG was imaged using 488-nm excitation and a 505-525-nm emission filter. The FV1000 was equipped with the ZDC (Zero Drift Controller) option, to maintain the same focus plane throughout the entire period of imaging.

The images were processed using ImageJ [Rasband, W. S., ImageJ, U.S. National Institutes of Health, Bethesda, Md., USA, http://rsb.info.nih.gov/ij/, 1997-2007] to determine fluorescence levels within cells as follows: First the despeckle filter (essentially a median filter with a 3×3 kernel) was applied to remove point noise and the SRG image was used to determine the cell boundaries; then, the average fluorescence intensity inside the cells (F(t)intracellular) was divided by the average fluorescence intensity in a region of interest outside the cells (<F(t)>extracellular). This procedure was adopted based on the assumption that there is insignificant depletion of labeled Tfn in the medium, so that the fluorescence in the medium should remain constant.

Analysis of fluorescent signals recorded in the green channel has shown that the SRG does not enter the cell, This had allowed the delineation of cell's boundaries in each frame. Then, the fluorescence levels within the bounded area were determined in the red channels for each time frame. Background fluorescence levels measured before the addition of Rhodamine Red-Tfn were subtracted from values measured in the same channel during ligand introduction.

### Immunoblotting Analysis

Equal protein levels of cell lysates were subjected to SDS-PAGE followed by quantitative immunoblotting analysis, using the highly specific H68.4 anti-human TfnR monoclonal antibodies [White et al., (1992) Biochim Biophys Acta 1136, 28-34], as described by Leyt et al., [(2007) Mol Biol Cell 18, 2057-71].

### Results

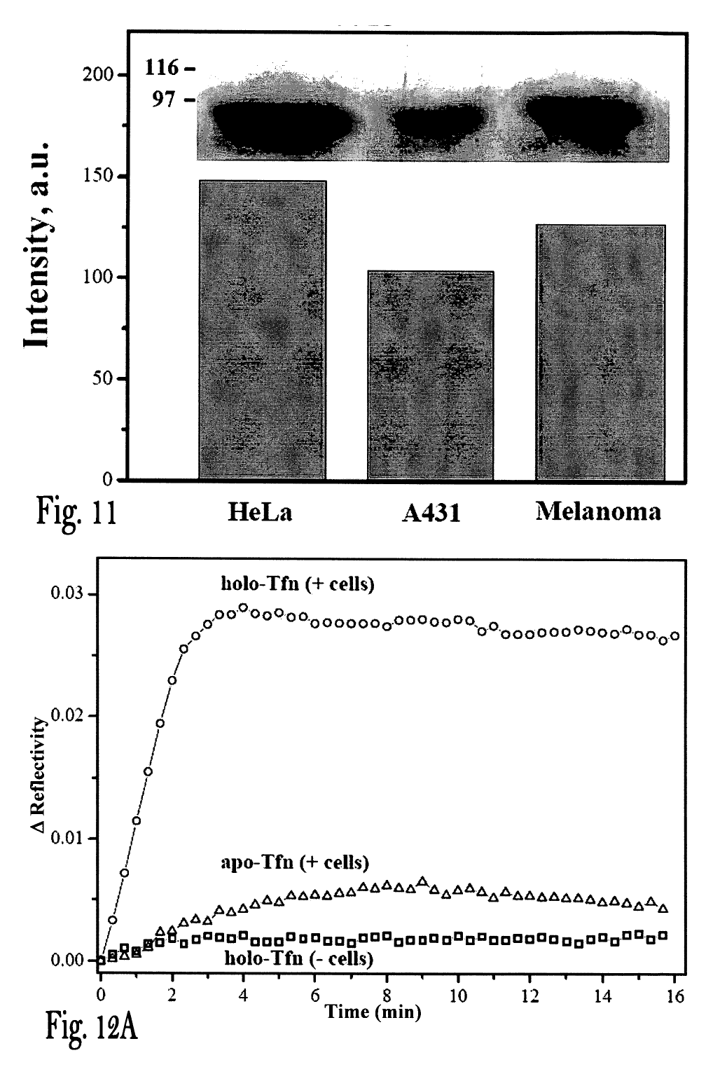

Melanoma cells express significant levels of the TfnR. Initially, it was essential to determine the conditions whereby cells, which express the TfnR, form a uniform monolayer on the surface of Au-coated ZnS prism. Following the application of specific cell culturing conditions described hereinabove it was found that among the cell-lines surveyed, HeLa (cervical carcinoma cells), A431 (epidermoid carcinoma cells), and human MEL 1106 cells, only the MEL 1106 cells formed a tight uniform monolayer of cells on the surface of an Au-coated ZnS prism (FIG. 8). Quantitative immunoblotting analysis, using the H68.4 anti-human TfnR monoclonal antibodies, showed similar levels of ˜90-kDa protein band, corresponding to the molecular weight of the human TfnR in all three cell-lines (FIG. 11 upper pannel). Since the melanoma cells grew more consistently as a uniform and tight monolayer on the gold film, these cells were chosen for further study.

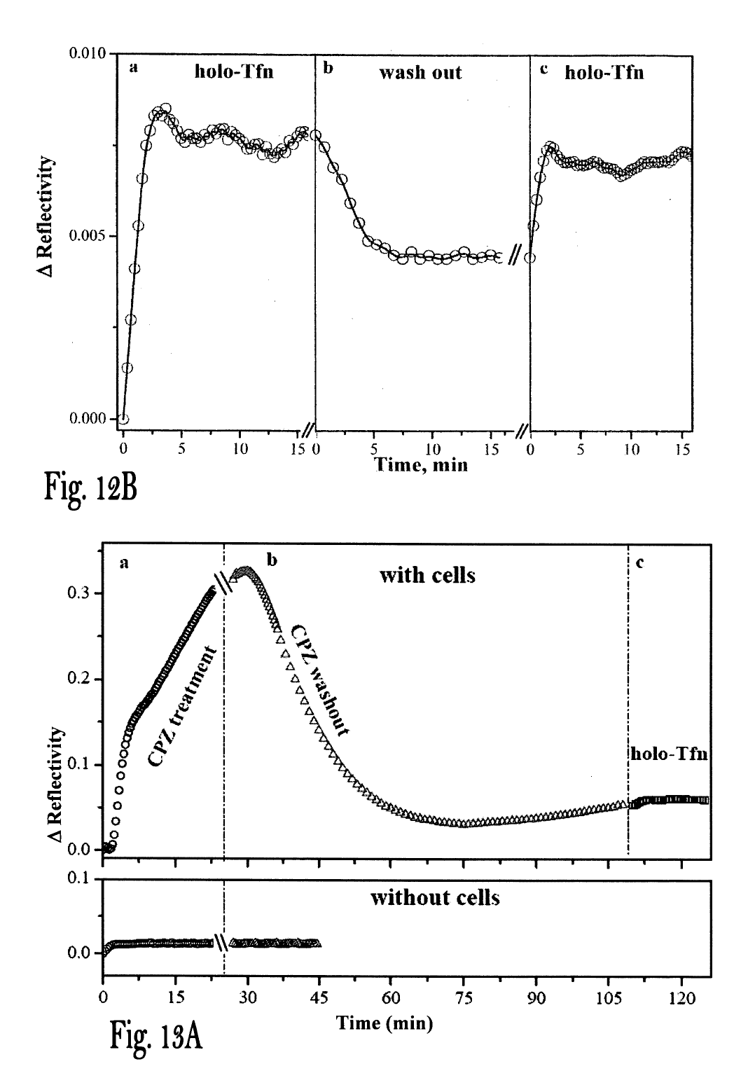

FTIR-SPR measurements of cells exposed to holo-Tfn detect small, but significant shifts of the SPR signal. Cells cultured on the Au-coated ZnS prism were exposed to holo-Tfn, and SPR measurements were conducted as described. Cells exposed to the ligand at 37° C. exhibited time-dependent shifts of the SPR minimum towards shorter wavelengths (“blue-shift”). The signal rapidly increased for about 2-3 minutes and leveled-off for the remaining measurement time (FIG. 12A, circles—holo-Tfn(+cells)). Addition of Tfn to an empty Au-coated prism had a negligible effect on the SPR signal shifts (FIG. 12A, rectangles—holo-Tfn(−cells)).

Apo-Tfn displays low binding affinity to the TfnR. Therefore, only minor levels of SPR signal shifts were expected to be observed upon cell exposure to the ligand. Indeed, compared with holo-Tfn, small SPR signal shifts were observed in response to apo-Tfn treatment (FIG. 12A, triangles—apo-Tfn(+cells)). These small changes could be attributed to the presence of residual iron-loaded ligand in the apo-Tfn preparation. Taken together, these results suggest that FTIR-SPR measurements sense a dynamic event evoked in response to cell exposure to holo-Tfn. Since receptor-mediated endocytosis via clathrin-coated pits is the main portal of Tfn entry into cells, it is realized that Tfn-induced endocytosis could have contributed to the SPR signal shifts.

With a ligand continuously present in the culture medium, trafficking of the receptor achieves a steady-state in which continuing uptake to endosomal compartments is balanced by its recycling back to the plasma membrane. This explains the roughly unaltered SPR signal observed after 2-3 mm of continuous holo-Tfn uptake (FIG. 12A, and FIG. 12B panel a). Removal of ligand from the medium would therefore lead to a net return of the internalized receptors and membranes back to the plasma membrane. Indeed, holo-Tfn removal (washout) contributed a red-shift in the SPR signal (FIG. 12B panel b), possibly due to recycling of internalized membranes back to the plasma membrane. Following ˜60 min of washout, introduction of holo-Tfn shifted the SPR signal again towards shorter wavelengths (FIGS. 12B panel c). This suggests that a fraction of TfnRs released their bound ligand, so became available to re-bind and internalize the second cohort of cargo.

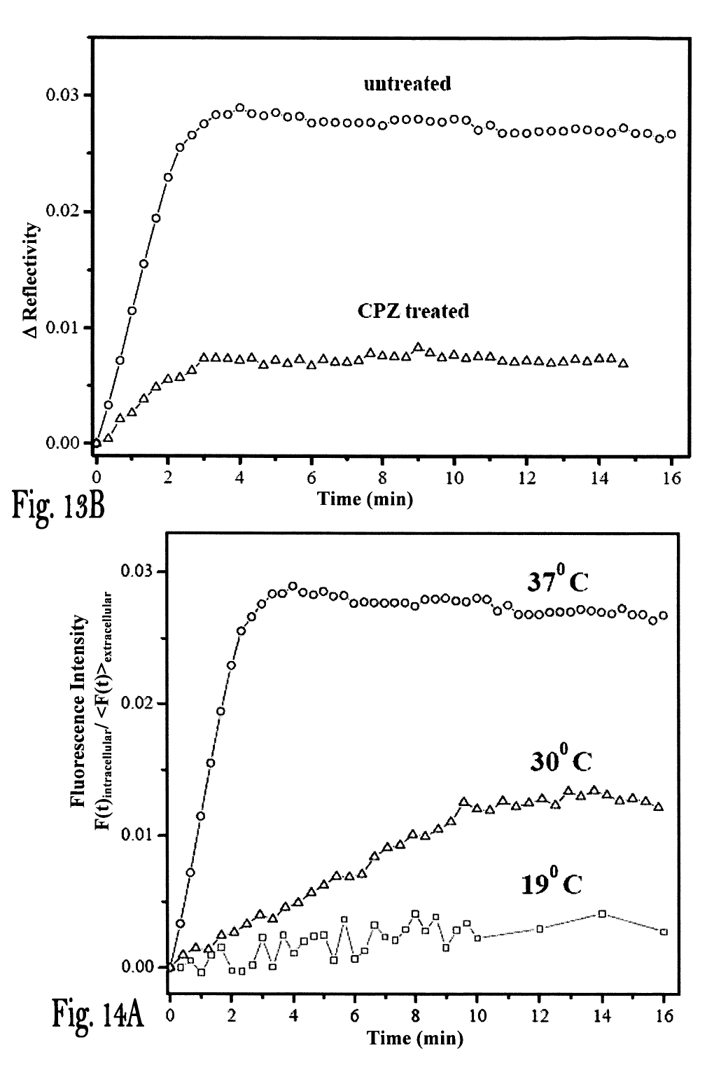

Chlorpromazine treatment diminishes Tfn-induced SPR signal shifts. The cationic amphiphilic drug, chiorpromazine (CPZ), inhibits clathrin coat assembly and transferrin internalization [Subtil et al., (1994) J. Cell Sci 107 (Pt 12), 3461-8]. To examine the effects of CPZ on holo-Tfn uptake, cells cultured on an Au/ZnS prism were first exposed to MEM/BSA containing 100 μM CPZ (CPZ hydrochloride—Alexis Biochemicals) at 37° C. Surprisingly, a sizeable shift of the SPR signal towards shorter wavelengths was observed immediately after cell exposure to CPZ (FIG. 13A, upper panel section a). Minimal changes in the SPR signal were observed when an empty prism was subjected to the same treatment (FIG. 13A, lower panel section a). These results suggest that the FTIR-SPR measurements detected cell-associated processes caused by the drug.

CPZ washout with plain MEM/BSA produced the opposite effect, that is, an ongoing decrease (“red shift”) in the SPR signal (FIG. 13A, upper panel section b). The shift of the SPR signal to the opposite direction is presumably caused in response to CPZ flowing out of the cells. Performing the same experiment without cells had no effect (FIG. 13A, lower panel section b). A steady SPR signal was measured after ˜30 min of CPZ washout. After approximately 90 min of CPZ washout, a typical Tfn uptake experiment was performed (FIG. 13A, upper panel section c). The results, shown at higher definition in FIG. 13B, revealed diminished SPR signal shifts, compared with untreated cells, suggesting that despite CPZ washout, SPR sensed CPZ-dependent inhibition of Tfn-induced endocytic processes. The observation that after 90 min of CPZ washout, the cells are still affected, is consistent with previous studies showing that under similar conditions, full recovery from CPZ mediated effects is achieved only after about 5 hours of drug washout [Orellana et al., (2006) Toxicol Appl Pharmacol 213, 187-97].

To confirm the effects of CPZ on Tfn endocytosis by an independent method, a fluorescence time-lapse microscopy was employed for recording in real-time the internalization of Rhodamine. Red-Tfn at 37° C. into live melanoma cells, as described herein above. Briefly, cells cultured on glass coverslips were exposed to holo or apo-Tfn, or first treated with CPZ followed by 90 min of drug washout, and then treated with holo-Tfn. Representative confocal images taken from a single focal plane of are shown in FIG. 10A upper, middle, and lower panels, correspondingly. Quantitative analysis of the accumulation of Rhodamine Red fluorescence within a confined cell area (exemplified in FIG. 10B) was carried out as described herein above. The results show that apo-Tfn accumulated within the cells at slower rates compared with holo-Tfn uptake into the cells. CPZ-treatment had also significantly decreased the rate of holo-Tfn uptake into the cells. These results correlate with apo-Tfn and CPZ-mediated impediment of holo-Tfn dependent effects on SPR signal shifts. It is noted that the rate of Rhodamine Red holo-Tfn uptake observed using time-lapse microscopy was markedly slower than that detected by the SPR experiments. These differences suggest that the two methodologies are sensitive to different steps of the Tfn endocytic pathway. While the fluorescence-based method detects primarily the accumulation of Tfn in endosomes, the SPR technique senses Tfn-stimulated production of small endocytic vesicles.

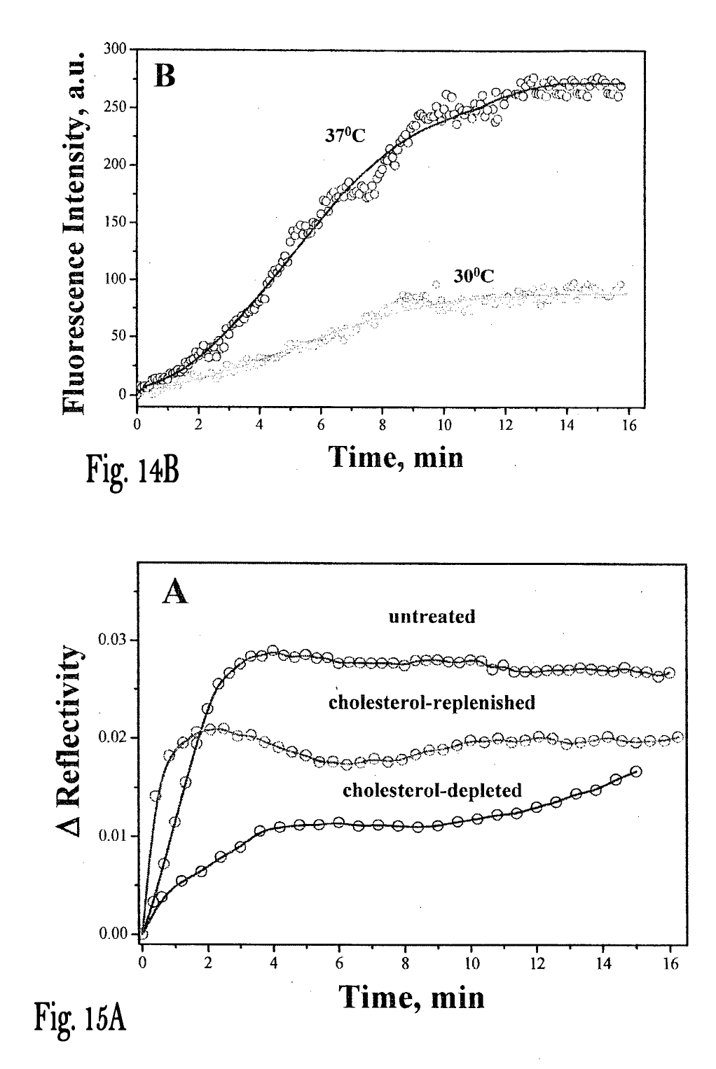

Tfn-induced SPR signal shifts are diminished at lower temperatures. It is well established that the efficacy of clathrin-coated pit-mediated endocytosis is significantly reduced at temperatures below 37° C., and nearly blocked at temperatures below 20° C. [Iacopetta and Morgan J Biol Chem 258, 9108-15]. Consistent with this observations, the FTIR-SPR experiments conducted on cells treated with holo-Tfn at different temperatures showed diminished SPR shifts at 19° C., larger SPR shifts at 30° C., and maximal shifts at 37° C. (FIG. 14A). Time-lapse fluorescence imaging of cells exposed to Rhodamine Red-holo-Tfn also showed reduced ligand internalization rates at lower temperatures (FIG. 14B).

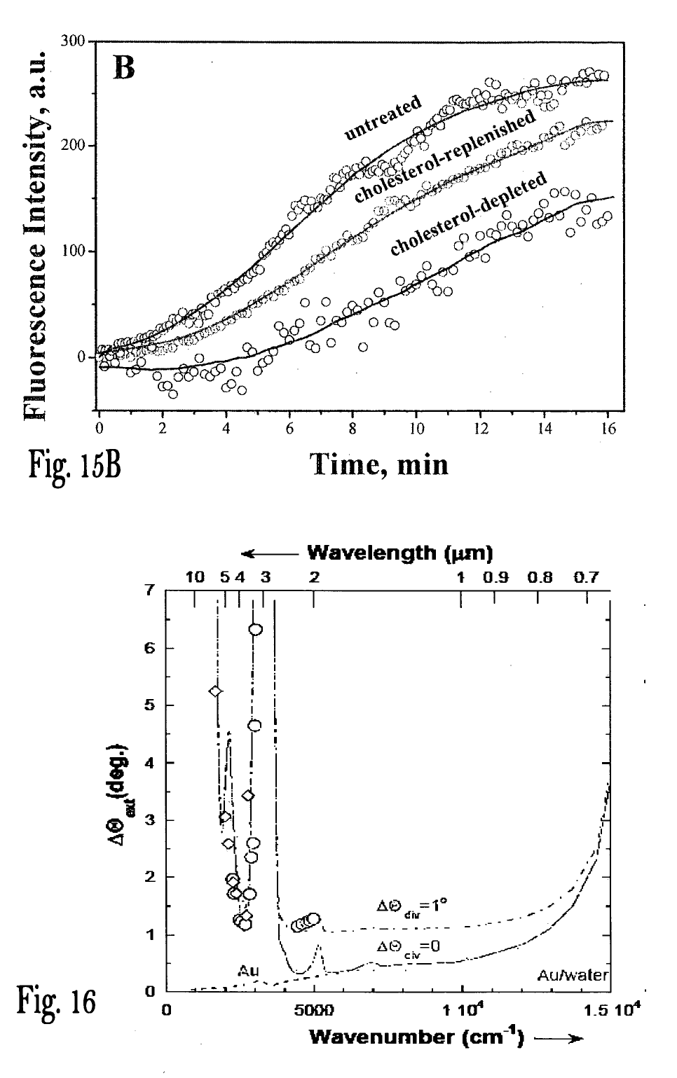

Tfn-induced SPR shifts are cholesterol dependent. Previous data have shown that plasma membrane cholesterol depletion by methyl-β-cyclodextrin (mβCD) treatment significantly diminishes the rate of clathrin-mediated endocytosis of various receptors, including TfnR [Leyt et al., (2007) Mol Biol Cell 18, 2057-71; Subtilet al., (1999) Proc Natl Acad Sci USA 96, 6775-80]. Cells cultured on an Au-coated ZnS prism were exposed to mpCD, as described by Ziblat, R., et al., [Biophys J:90, 2592-2599, 2006]. The agent was rapidly removed by cell rinsing with plain MEM/BSA. Holo-Tfn was then immediately introduced into the flow chamber and SPR measurements were conducted at 37° C. The SPR signal shift in mβCD-treated cells was diminished compared with untreated cells (FIG. 15A). Cholesterol replenishment by cell exposure to mβCD-chol partially rescued the holo-Tfn-induced SPR signal shifts, which reached plateau levels somewhat lower than untreated cells (FIG. 15A). Quantitative analysis of time-lapse imaging of Rhodamine Red holo-Tfn uptake under similar conditions showed a similar trend in the efficiency of ligand uptake in response to cholesterol depletion and replenishment (FIG. 15B).

These results suggest that FTIR-SPR measurements provide a promising biophysical approach to study in a real-time and in a label-free manner, processes related to endocytic uptake of macromolecules. The results show that the FTIR-SPR technique of the invention measures the refraction index of a cell layer with high precision. Blue shift of the SPR resonance were observed upon cell exposure to holo-Tfn, corresponding to a decrease in the average refraction index of cells by Δn=−4*10⁻⁴ (FIG. 12A). Changes in the refractive index were significantly smaller when cells were treated with apo-Tfn, or when endocytosis was partially arrested (Δn is smaller than −1*10⁻⁴).

The results obtained further suggest that the SPR senses Tfn-induced formation of endocytic vesicles. The appearance of these newly made vesicles in the cell cytoplasm may have contributed to the observed SPR blue shifts in Tfn-treated cells, which is further supported by estimating the refractive index change contributed by newly formed endocytic vesicles of known size and shape in the cell's cytoplasm, as further discussed below.

It is interesting to note that CPZ treatment per se resulted in a blue shift in the SPR signal that was 10 times larger than that induced by Tfn (FIG. 13A). Previous studies have shown that the CPZ treatment greatly weakens cell attachment to the substratum, so that the cell surface contacting the substrate (and thus the projected cell surface area) becomes significantly smaller [Hueck et al., (2000) Am J Physiol Cell Physiol 278, C873-8.]. This phenomenon could explain the strong blue-shift of the SPR in the CPZ-treated cells (FIG. 13A), because weakened cell adhesion can lead to cell body displacement away from the substrate. The void generated between the cell and the substrate is filled with water-based growth medium, which has a lower refractive index than the cell body, thus contributing to the large SPR blue shifts.

### Example 2

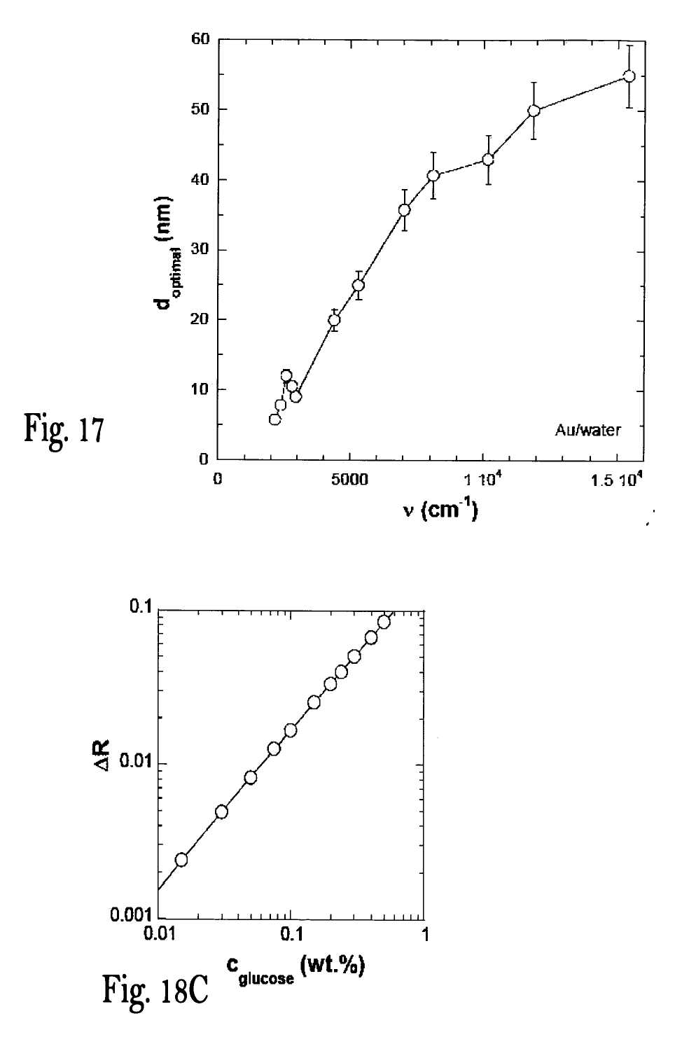

The following examples provide several biological applications of the FTIR-SPR technique of the invention. The experimental setup is based on the setup shown in FIG. 3A, utilizing the Bruker Equinox 55 FTIR spectrometer with a tungsten lamp equipped with the KBr beam splitter as a light source. For the 1-mm-diameter pinhole, the beam diameter is about 3-4 mm and the beam divergence is Δθ_{div}=0.8°. The collimated beam passes through the grid polarizer (Specac, Ltd.) and is reflected from the right-angle ZnS prism (ISP Optics, Inc.) mounted on a θ-2θ rotating table. The additional parabolic mirror focuses the reflected beam on the liquid-nitrogen-cooled MCT (HgCdTe) detector. A temperature-stabilized flow chamber (with a volume of about 0.5 ml) is in contact with the gold-coated base of the prism. The gold film thickness is chosen according to the targeted wavelength (FIG. 17). To operate this setup, an appropriate incident angle was chosen. Then the sample was mounted and the reflectivity spectrum for the s-polarized beam was measured, which is used as a background for further measurements. Thereafter, the reflectivity spetrum for the p-polarized beam was measured. Normally, this is done with 4 cm⁻¹ resolution and 16 scan averaging.

### Glucose Concentration in Water

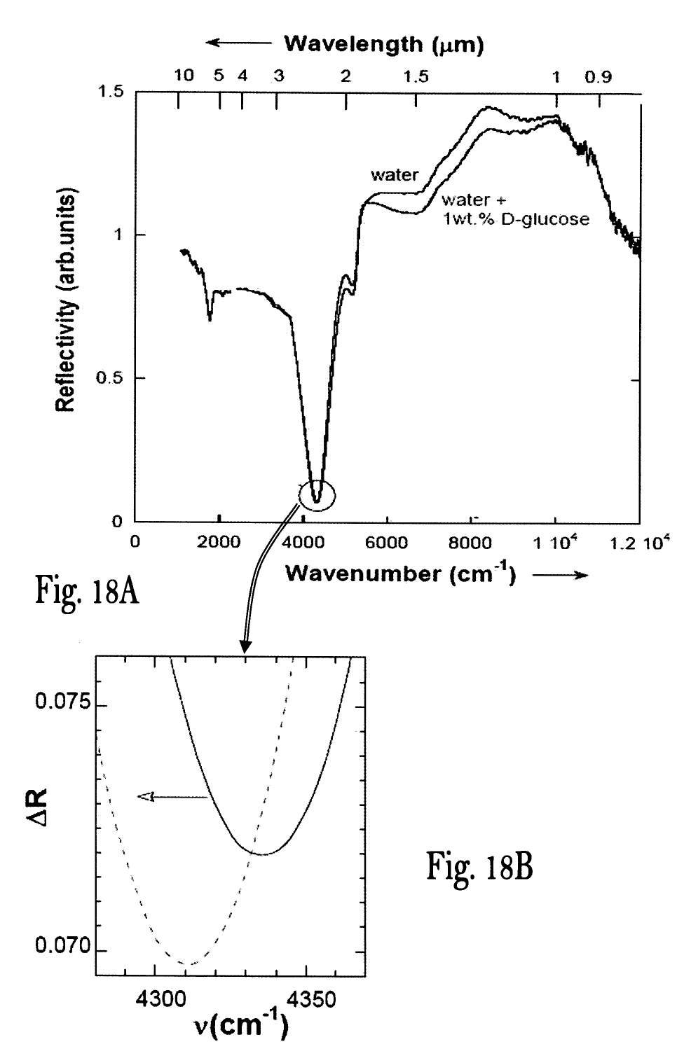

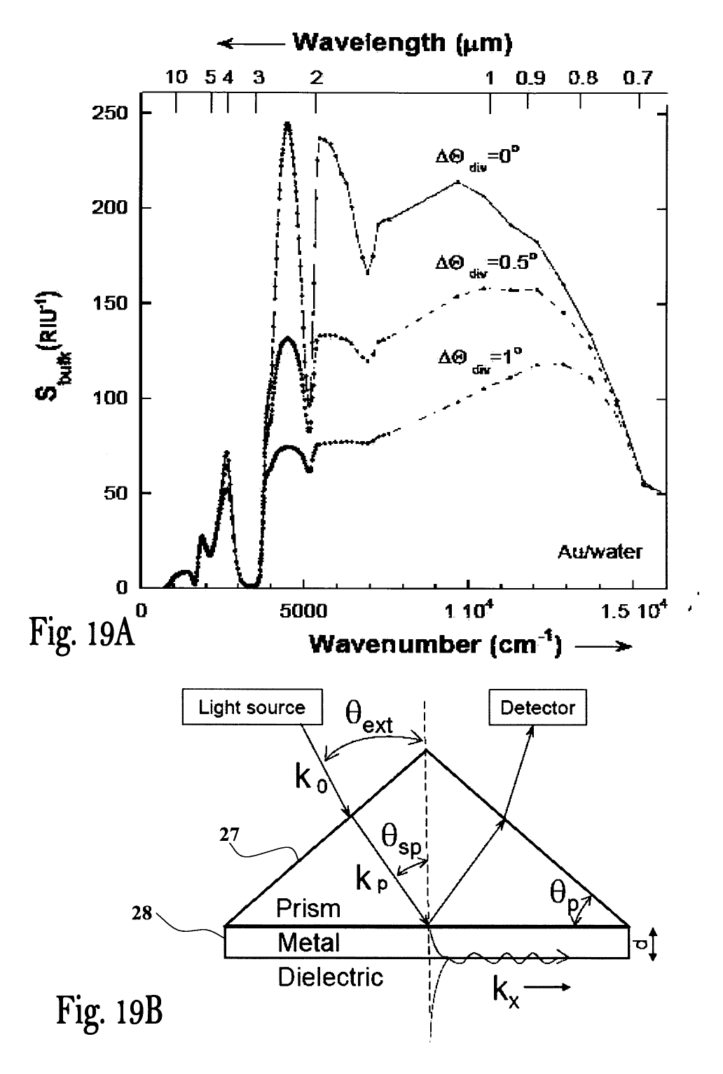

The FTIR-SPR technique of the invention was used for precisely measuring the refractive index of solutions in order to monitor physiologically important glucose concentrations in water and in human plasma. FIG. 18A shows the reflectivity spectra of pure water and of 1% D-glucose solution measured using the FTIR-SPR setup of the invention. The surface plasmon resonance for the Au/water interface is manifested by a pronounced dip at 4334 cm⁻¹. Addition of 1 wt. % of D-glucose shifts this dip to 4310 cm⁻¹ (FIG. 18B). A secondary dip at 1780 cm⁻¹ is a long-wavelength surface plasmon; the features at 5145 cm⁻¹ and at 6900 cm⁻¹ indicate the water absorption peaks. The spectral range around 4000 cm⁻¹ corresponds to the short-wavelength SPR, and the small peak at 2000 cm⁻¹ corresponds to the long-wavelength SPR. Adding glucose affects the whole reflectivity spectrum, in such a way that the SPR resonance is red-shifted. The maximal reflectivity change occurs at 4600 cm⁻¹. FIGS. 18B and 18C shows that the reflectivity at 4600 cm⁻¹ linearly increases with the increasing in the glucose concentration. The slope of this linear dependence yields sensitivity, S_{bulk}=θR=∂n=75 RIU⁻¹. Taking into account the actual beam divergence of 0.8°, the experimental sensitivity is consistent with the sensitivity approximation given by the equation (FIG. 19A):

$${S}_{bulk} \approx \frac{1}{ΔΘ} \frac{\partial {Θ}_{ext}}{\partial n}$$

Where θₑₓₜ denotes an external incident angle, Δθ denotes the SPR width, n denotes the refraction index, as illustrated in FIG. 19B. FIG. 19A shows the bulk sensitivity of the FTIR-SPR technique of the invention estimated according to the above equation. The bulk sensitivity in the infrared range is considerably higher than that in the visible range. In the wavelength range 0.6-2.5 μm, the sensitivity is more or less constant, whereas in the long-wavelength window, 3.3-5 μm, it is lower but is still comparable to that in the visible range. This means that both these spectral windows may be used for SPR-spectroscopy.

### Example 3

### Glucose Uptake by Erythrocytes

In the following section measurements of glucose uptake by erythrocyte suspension in the PBS medium are described. Briefly, fresh human red blood cells (RBCs) were washed four times in PBS by centrifugation. The supernatant and buffy coat cells were discarded and RBCs were resuspended in glucose-free PBS to yield cₑ=5% v/v. For complete glucose depletion, cells were incubated for 60 min at 22° C. in PBS. Then, RBCs were centrifuged and resuspended in fresh PBS containing the required concentrations of D-glucose supplemented with L-glucose, to keep the total glucose concentration (osmolarity) equal to 20 mM. The SPR measurements were performed at 22° C. to slow down cellular glycolysis.

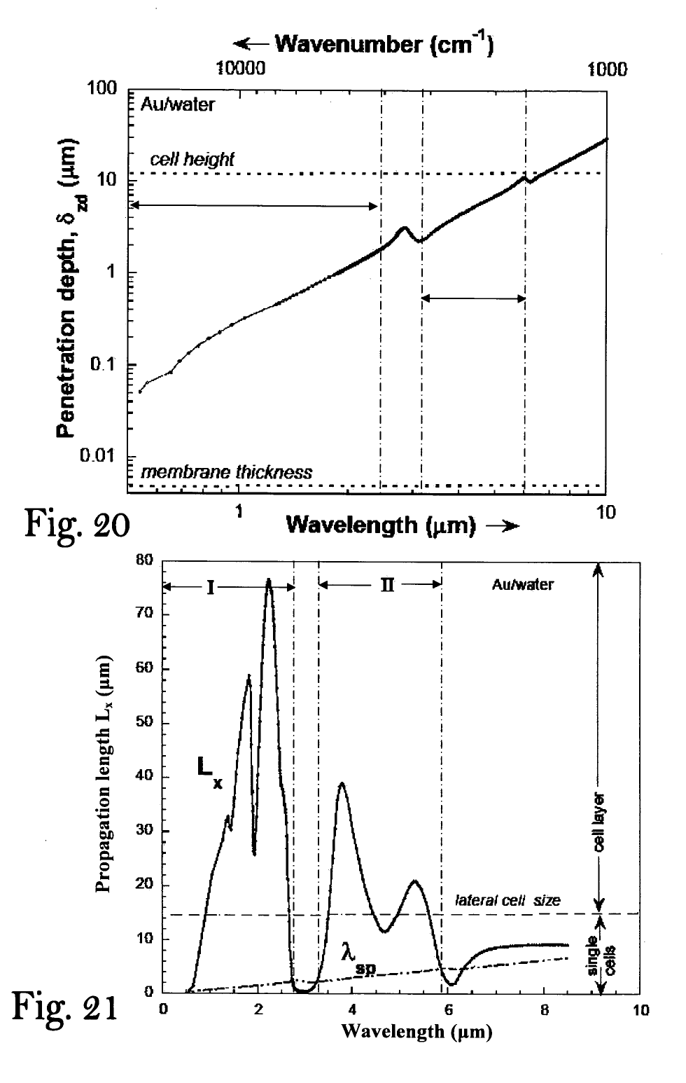

The measurements were performed using a ZnS prism coated with a 12-nm thick Au film. It was decided to operate the FTIR-SPR setup with λ=4 μm wavelength at which the surface plasmon penetration depth, δ_{zd}=4.5 μm (FIG. 20), is comparable to the typical erythrocyte diameter. Although the sensitivity at this wavelength is low (FIG. 19A), the use of such a long wavelength here is mandatory in order to sense the processes inside erythrocytes. The average distance between the erythrocytes is Dₑcₑ^{1/3}=17 μm. The surface plasmon propagation length, Lₓ=30 μm (FIG. 21), exceeds the distance between erythrocytes. Hence, in the “coherence area” of the surface Plasmon wave, (δ_{zd}×Lₓ), there are 1-2 erythrocytes.

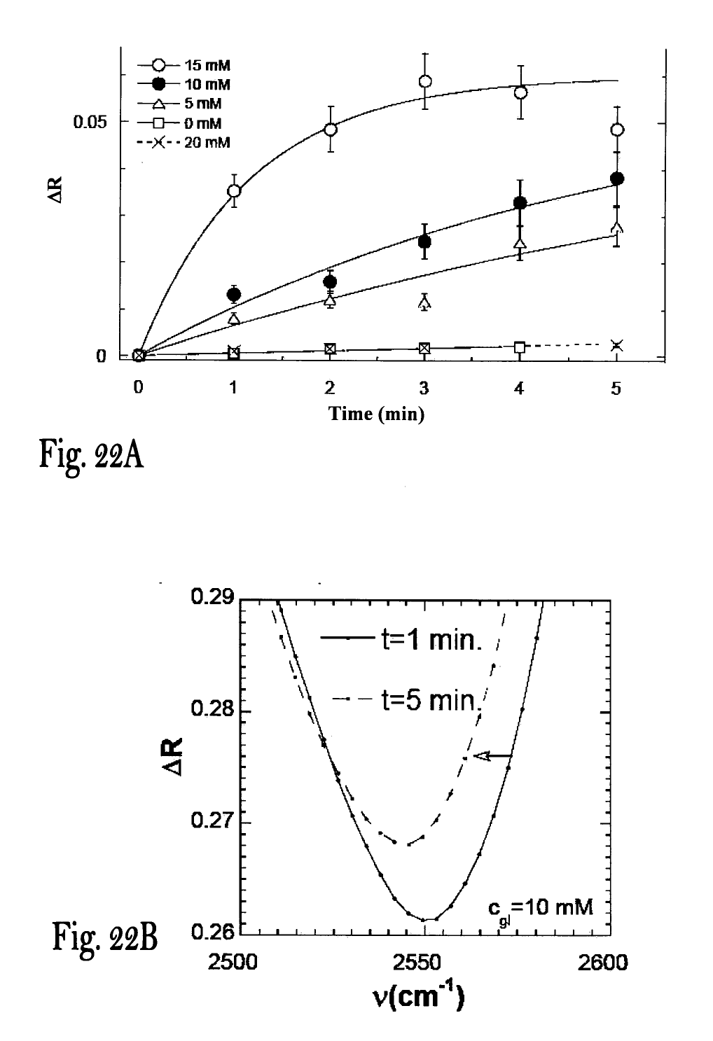

The erythrocytes intensively absorb D-glucose, which affects their refraction index and probably their shape. The optical reflectivity from the erythrocyte suspension changes correspondingly. Indeed, FIG. 22A shows that, upon addition of D-glucose, reflectivity in the SPR regime rapidly increases with time, until saturation is reached. The rate of this process increases when cells are exposed to higher glucose concentrations.

### Example 4

### Cell Culture Studied By the SPR

Cells cultures were successfully grown directly on the Au-coated prism. These include human Melanoma (MEL 1106), MDCK, and HeLa cells that form monolayers with a typical confluence of 60-80%. In a typical experiment, the prism with a cell culture was removed from the incubator, attached to a flow chamber, mounted in the FTIR-SPR setup of the invention, and then exposed to plain buffer medium (MEM) at 37° C. The temperature in the flow chamber was controlled within 0.1° C. while the buffer solution was constantly streamed through the chamber at a flow rate of 5 μl/min using a motorized bee syringe pump. After 5-7 minutes of equilibration, reflectivity in the SPR regime was measured. The measurements lasted up to 6 hours, after which, the cells usually die, most probably from the lack of CO₂.

### Surface Plasmon Propagation in the Cell Culture

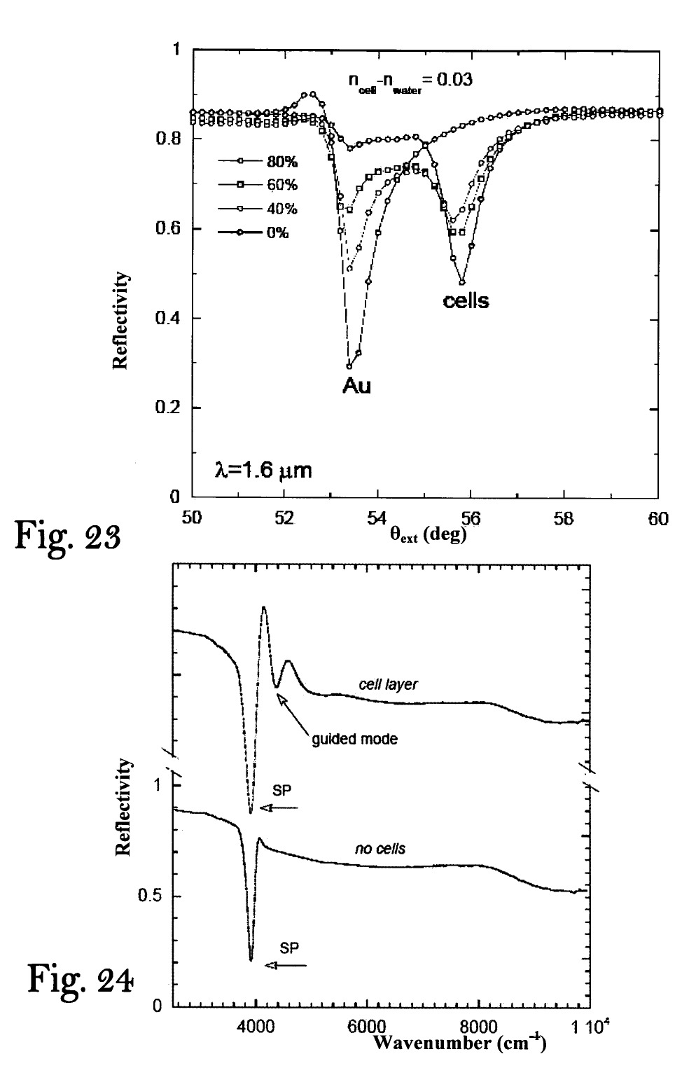

The cells have irregular shapes with a lateral size of ˜10×20 μm² and a height of 1 to 6 μm. Since the cells contain up to 25% organic molecules, their average refractive index exceeds that of water. This results in an angular shift of the SPR resonance for the ZnS/Au/cell interface, compared with the ZnS/Au/water interface. However, even at high cell confluence, some parts of the Au-coated prism are still uncovered by cells. These Au patches may exhibit an unshifted SPR, provided their size exceeds the SP propagation length, lpatch>Lx. FIG. 23 summarizes studies of the HeLa cell monolayers grown on an SF-gold-coated glass prism. Here relatively short wavelength λ=1.6 μm was used. The corresponding penetration depth is also small, δ_{zd}=0.7 μm (FIG. 20) but sufficient to probe the cell's interior. The propagation length, Lₓ=46 μm (FIG. 21), exceeds the average cell size. FIG. 23 shows angular-dependent reflectivity for different cell coverages (confluences). In the absence of cells, there is a single dip at Θₛₚ=53.4° that corresponds to the surface plasmon resonance at the ZnS/Au/water interface. In the presence of HeLa cells, an additional dip appears at Θₛₚ=55.8° that corresponds to the ZnS/Au/HeLa cell interface. The SPR angular shift corresponds to n_{cell}−n_{water}=0.03. For high cell confluence, e.g., 80%, the SPR from uncovered gold patches is barely seen, as expected.

### Guided Modes

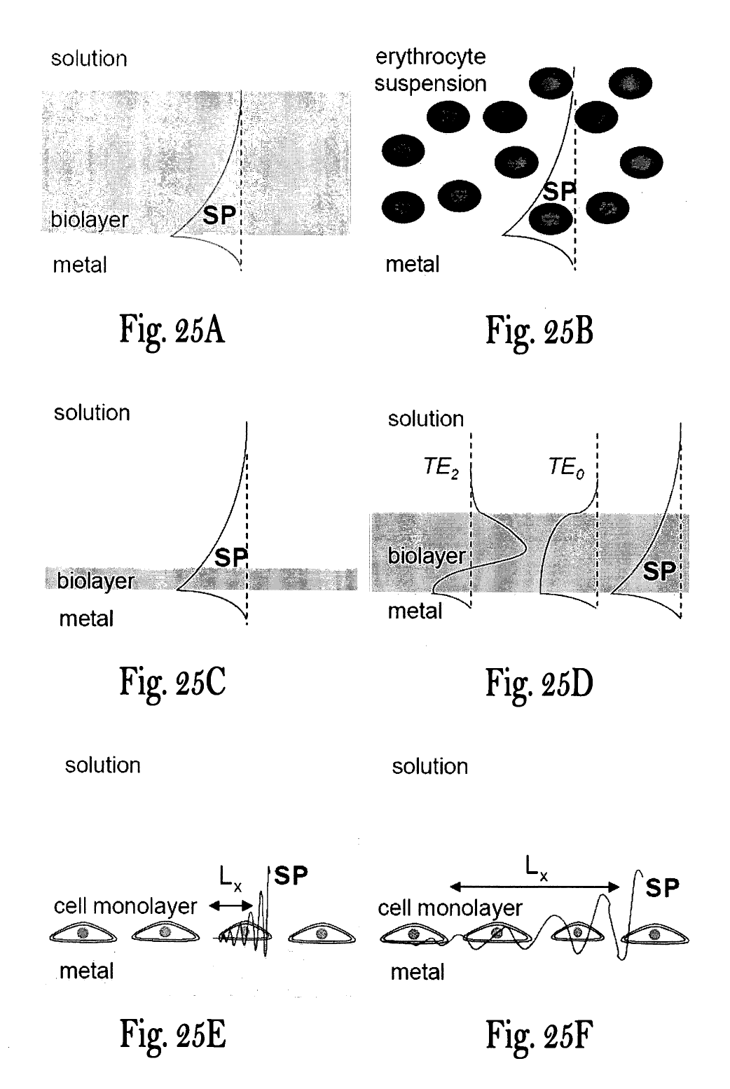

Since the refractive index of cells exceeds that of the surrounding aqueous medium (n_{cell}>n_{water}), and the cell monolayer thickness is comparable to the mid-infrared wave-length (d_{cell}˜λ), the cell monolayer on gold could behave as a metal-clad optical waveguide [Yariv et al., J. Wiley, N.Y., 1984, p. 473]. An indication of such behavior is seen in FIG. 24, which shows an SPR spectra: (i) for a high-confluence human MEL 1106 cell monolayer grown on an Au-coated ZnS prism; and (ii) for the similar Au-coated prism without cells. In both cases, there is a strong surface plasmon resonance at 3920 cm⁻¹ (λ=2.55 μm). For the prism with cell culture, a short-wavelength satellite appears at 4385 cm⁻¹ (λ=2.28 μm). This feature is believed to be associated to the waveguide mode propagating in the cell monolayer (FIG. 25d).

Indeed, the cut-off condition for the TE and TM modes in the planar metal-clad dielectric waveguide is [Knoll, Annu. Rev. Phys. Chem. 49, 569 (1998); Yariv and Yeh, J. Wiley, N.Y., 1984, p. 473]:

$${k}_{0} {d}_{cell} \sqrt{{n}_{cell}^{2} - {n}_{water}^{2}} = ( m + \frac{1}{2} ) π$$

where m=0, 1, . . . , k₀ denotes the wave vector in free space, d_{cell} denotes the cells thickness, and in this case the following parameters are substituted: n_{water}=1.25, n_{cell}−n_{water}=0.03, d_{cell}=2 μm; for the lowest TE0 mode it was found that λ₀=2.3 μm (ν=4348 cm⁻¹). This estimate fairly corresponds to the observation shown in FIG. 24. It is noted that the surface plasmon propagation length at this wavelength is very long, Lₓ=73 μm (FIG. 21), as expected.

The waveguide modes in cell culture may develop into a useful tool to study cell-cell attachment and cell adhesion to substrates.

### Example 5

### Cholesterol in the Cell Membrane

The penetration of cholesterol into the plasma membrane of the HeLa cells was studied with the FTIR-SPR technique of the invention (similar studies using SPR in the visible range were reported by Besenicar et al., [Biochimica et Biophysica Acta-Biomembranes, 177, 175 (2008).]. It is well-known that cholesterol enters mostly into the plasma membrane rather than into cytoplasm. Therefore, to achieve high sensitivity to membrane-related events, the near-infrared wavelength range was chosen, λₛₚ=1÷1:08 μm, characterized by a relatively low SPR penetration depth.

The HeLa cells were grown on an SF-11 glass prism coated with 35-nm-thick gold film. The prism with the cells was mounted into a flow chamber and was equilibrated in growth medium for 5-7 minutes at 37° C. Then 10 mM of mfβCD-chol (methyl-beta-cyclodextrin loaded with cholesterol) was added, which is known to enrich the cells by cholesterol. The FTIR-SPR spectra was measured before and after adding the drugs. FIG. 26 shows that after exposure to mβCD-chol (10 μM at t=0), the SPR is red-shifted. This corresponds to a refractive index increase because cholesterol has a higher refractive index than water. In contrast, when a similar chemical, mβCD, which is not loaded with cholesterol, was added (at t=15 for 3 min) to a growth solution the SPR is blue-shifted, which corresponds to a refractive index decrease. This is expected since a similar chemical, mβCD, which is not loaded with cholesterol, CD depletes plasma membranes from cholesterol. Consistent with this explanation, the SPR reflectivity in the cholesterol-depleted state is lower than the initial SPR reflectivity.

### Example 6

### Ferrotransferrin Uptake

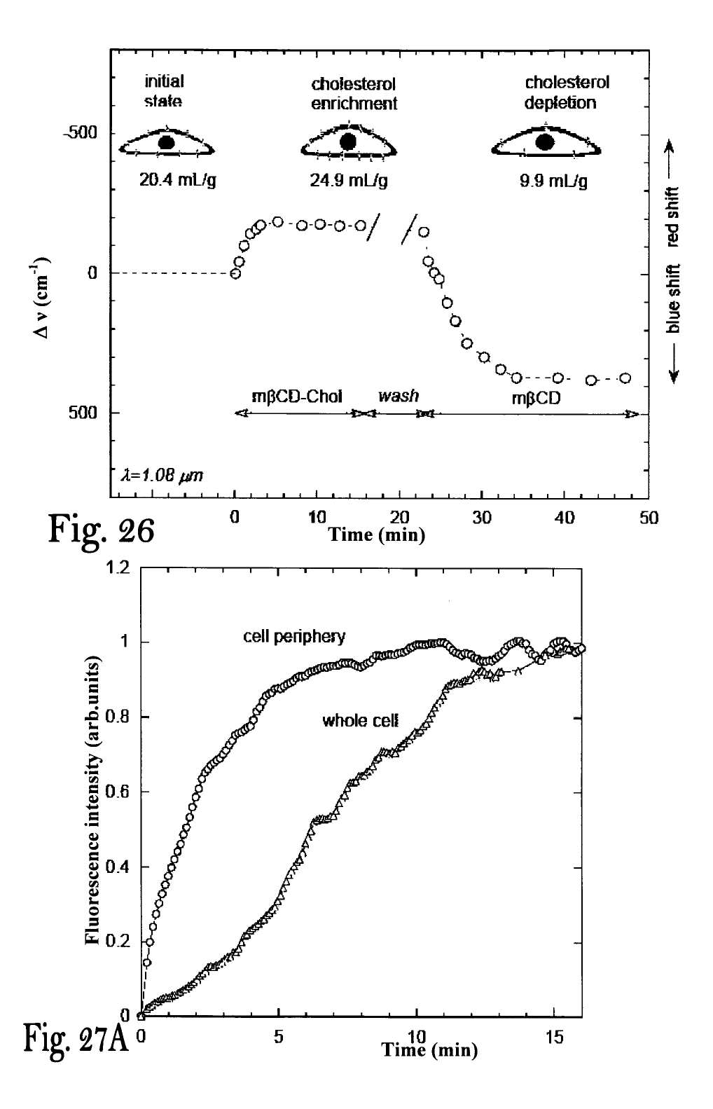

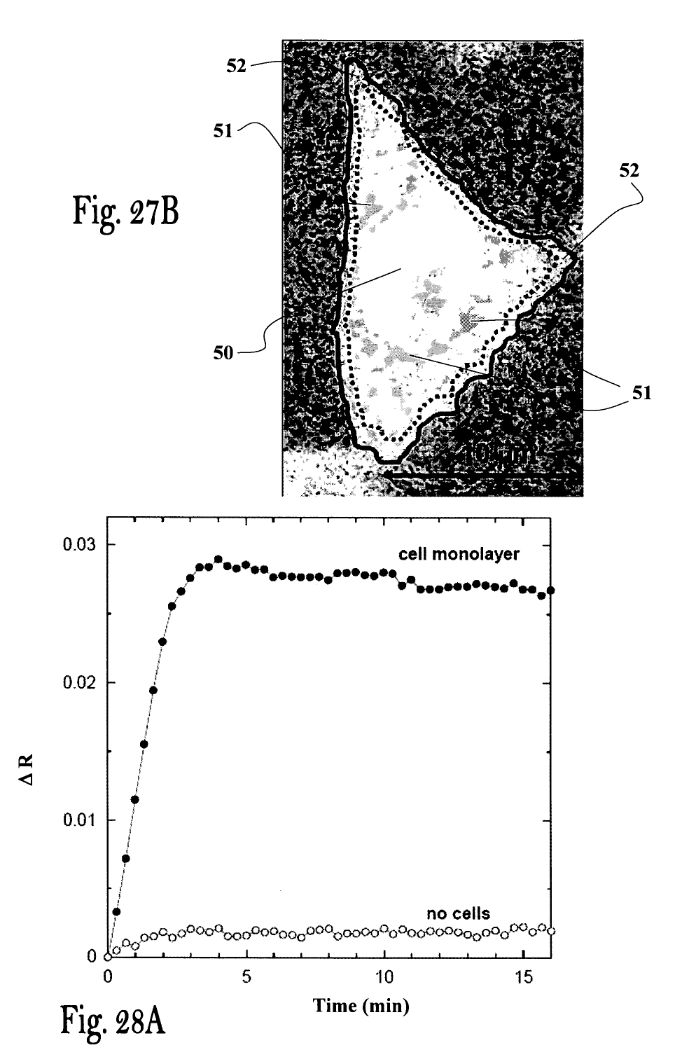

The FTIR-SPR technique of the invention was applied to study transferrin-induced clathrin-mediated endocytic processes that introduce Fe ions into the cell. FIG. 27A shows a fluorescence image of the Melanoma 1106 cell obtained by confocal microscopy [imaged with an Olympus FV-1000 confocal microscope, equipped with an on-scope incubator (Life Image Services)—the holo-Ft was tagged with Rhodamine Red]. FIG. 27B shows the cell interior 50, the Fe penetration areas 51, and extra-cellular space areas 52. It is clearly seen that the fluorescence intensity increases and then achieves saturation, whereas its kinetics in the peripheral part of the cell is faster than that in the whole cell.

The same process was studied using a long-wavelength surface plasmon at λ=2.54 μm. Its penetration depth, δ_{zd}=1.2 μm (FIG. 20), is deep enough to penetrate the cells, although it senses mostly the cell periphery. FIG. 28A shows SPR reflectivity variation upon introduction of holo-Ft into the solution. The kinetics of the SPR reflectivity closely follows the fluorescence kinetics in the cell periphery (FIG. 27A), as expected. This example demonstrates that the SPR results are consistent with the confocal microscopy observations using fluorescent tags. The obvious advantage of the SPR technique is that it is label-free. Interestingly, the SPR here is blue-shifted, indicating that the average refractive index in the measured volume decreases (FIG. 28B). This rules out the possibility that the SPR shift results from accumulation of organic molecules in the cell (this would increase the refractive index). The blue shift indicates that the cells become “diluted”, as if the growth solution penetrates into cells. This is consistent with the biological picture of endocytosis that includes transferrin-induced vesicular transport.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1-46. (canceled)

47. Apparatus for measuring optical reflectivity by Surface Plasmon Resonance at the surface and/or inside living cells attached to a thin electrically conducting film, comprising:
light source for producing a light beam, prism having base and side surfaces, wherein said base surface is coated by said thin electrically conducting film; beam processing means capable of collimating and/or polarizing said light beam and directing it to the coated base of the prism such that said beam is internally reflected by said prism at its base; detector means capable of measuring the intensity and optionally also polarization or phase of a reflected beam,
wherein the beam processing means comprises polarizing means and two parabolic, circular or elliptic, mirrors,
and wherein the light source is an infrared light source capable of emitting a light beam in the 0.75 to 12 micrometer wavelength range.

48. An apparatus according to claim 47 wherein the base surface of the prism is horizontal or vertical to ground surface.

49. An apparatus according to claim 47 further comprising means for taking measurements from at least two different regions on the prism base.

50. An apparatus according to claim 47 further comprising a flow chamber in contact with said thin electrically conducting film, or a portion thereof, for prolonging the life of the living cells.

51. An apparatus according to claim 47 further comprising in the light path of the reflected or incident beam a shutter or iris for illumination or measuring different regions of the sample.

52. An apparatus according to claim 47, wherein the thin electrically conducting film is a gold film having thickness in the range of 10-50 nm.

53. An apparatus according to claim 47, wherein the prism is made of ZnS.

54. An apparatus according to claim 47, wherein the thin electrically conducting film is attached to a replaceable surface capable of being attached to the base surface of the prism while being optically coupled to said prism.

55. An apparatus according to claim 54, wherein the replaceable metal-coated surface is attached to the prism according to the Kretschmann's configuration.

56. An apparatus according to claim 47, wherein the thin electrically conducting film is composed from a number of metal patches of about 5×5 μm to 200×200 μm and having thickness in the range of about 10 to 50 nm.

57. An apparatus according to claim 47, wherein the light source is selected from: single wave length; or multi wavelength.

58. An apparatus according to claim 47 further comprising optical means for conveying the light from the light source to the base surface of the prism, and for conveying the reflected beam to the detector means, wherein said optical means are moveable and the prism is a rotatable prism adapted to obtain a desired angle of incidence.

59. An apparatus according to claim 47 further comprising optical means for conveying the light from the light source to the base surface of the prism, and for conveying the reflected beam to the detector means, wherein the prism is a movable prism and said optical means are rotatable adapted to obtain a desired angle of incidence.

60. An apparatus according to claim 47 for measuring optical reflectivity by surface plasmon resonance on moieties attached to the thin electrically conducting film, wherein said thin electrically conducting film is a detachable metal coated surface capable of being optically coupled to the base surface of the prism.

61. An apparatus according to claim 60 in the Otto configuration.

62. An apparatus according to claim 60 wherein the moieties are selected from living cells, bacteria, molecules, solutions, membranes.

63. A method for measuring optical reflectivity by surface plasmon resonance at the surface and/or inside living cells attached to a thin electrically conducting film, comprising:
(a) providing an apparatus as defined in claim 47;
(b) placing the cells, membranes, solutions, or bacteria on the metal coated surface;
(c) irradiating the cells by a light beam in the near-infrared and/or mid-infrared wavelength ranges;
(d) establishing the angle of incidence corresponding to the excitation of the surface Plasmon resonance; and
(e) measuring reflectivity.

64. A method according to claim 63 wherein measuring of the reflectivity comprises measuring the intensity, the polarization, and/or phase of the reflected beam.

65. A method according to claim 63 wherein the measurement of step (e) is carried out at a single wavelength or by measuring at several wavelengths.

66. A method according to claim 63 wherein measurements are taken from at least two regions in the sample, simultaneously or sequentially.

67. A method according to claim 63 wherein the angle of incidence is varied in the range that enables surface plasmon resonance.

68. A method according to claim 63 further comprising: applying to the cells an external stimuli.

69. A method according to claim 68 wherein the external stimuli is selected from: irradiation, Temperature, pH, ionic contact; Effector molecules, drugs, hormones, metabolites, eukaryotic cells, prokaryotic cells, viruses, phages.

70. A method according to claim 63, wherein the apparatus provided in step (a) is an apparatus as defined in claim 60.
